(19) United States
(12) Patent Application Publication
(10) Pub. No.: US 2011/0222483 A1
(43) Pub. Date: Sep. 15, 2011

(54) RADIO COMMUNICATION APPARATUS, RADIO COMMUNICATION SYSTEM, AND RADIO COMMUNICATION METHOD

(75) Inventors: Yasuaki Yuda, Kanagawa (JP); Masayuki Hoshino, Kanagawa (JP); Katsuhiko Hiramatsu, Leuven (BE)

(73) Assignee: PANASONIC CORPORATION, Osaka (JP)

(21) Appl. No.: 12/672,154

(22) PCT Filed: Aug. 12, 2008
(86) PCT No.: PCT/JP2008/002202

§ 371 Date: Feb. 4, 2010

(30) Foreign Application Priority Data
Aug. 15, 2007 (JP) P2007-211894

(51) Int. Cl. H04W 72/04

(52) U.S. Cl. 370/329

(57) ABSTRACT

In the data transmission such as MCW, or the like using multiple streams, errors can be suppressed in feedback information while reducing an amount of information required for feedback every stream. A radio communication apparatus for performing data transmission by multiple code words in multiple streams and blanking transmission at retransmission, includes a Nack detector which detects Nack as a response signal that responds to a received result of code words from a communication partner station; a CQI bit number allocation deciding section which changes an allocation of CQI bit numbers between the multiple streams when Nack is detected; a feedback CQI information generator which generates CQI information of each stream; and a feedback information transmitter which transmits feedback information containing Ack/Nack information, ranking information of each stream, and generated CQI information.

### TECHNICAL FIELD

The present invention relates to a radio communication apparatus, a radio communication system, and a radio communication method, which are applicable to MIMO (Multiple Input Multiple Output) for performing communication by using multiple antennas, and the like.

### BACKGROUND ART

In 3GPP (3rd Generation Partnership Project), etc. as the international standization organization for mobile communication, as the communication system that realizes the high-speed data transmission, the packet transmission system using the hybrid-ARQ (Hybrid-Automatic Repeat reQuest) (referred to as “HARQ” hereinafter), in which the coding and the retransmitting technology are employed in combination, is contemplated. Also, as the system that realizes the higher-speed and larger capacity data transmission, the space division multiplexing (SDM) transmission as one of the MIMO transmission is observed with interest. The MIMO transmission denotes the technology that transmits a signal by using multiple antennas in both the transmission and the reception, and the SDM transmission denotes the technology that multiplexes difference signals (streams) in space by using multiple antennas. By use of this SDM transmission, a frequency utilization efficiency can be increased not to expand the resource such as time or frequency.

In SDM, a frequency utilization efficiency can be improved much more by applying AMC (Adaptive Modulation and Coding) that controls adaptively a modulation scheme and a coding rate (MCS: Modulation and Coding Scheme) every stream. In AMC, the receiver side feeds back CQI (Channel Quality Indicator) indicating a received quality to the transmitter side, and the transmitter side chooses MCS responding to the fed back CQI. When AMC is applied stream by stream, CQIs of respective streams must be fed back. The data sequence as a control unit of such MCS is called the code word (CW), and the transmitting method that employs multiple code words to control the code word every stream is called MCW (Multiple Code Word).

Also, in order to apply to the cellular environment from the neighborhood of the base station to the cell edge, CQI that possesses a dynamic range of about 30 dB in terms of SINR (Signal to Interference and Noise Ratio) is needed. In order to cause AMC to function with good precision, CQI that represents the dynamic range of about 30 dB by a step of about 1 dB is employed in the standardization such as 3GPP, or the like. That is, 5-bit (32 steps) information is required for one CQI.

As the HARQ system in MCW in the background art, Blanking as given in Non-Patent Literature 1 (referred to as the “blanking” hereinafter) is employed. The blanking is the technology that is explained as follows. First, each code word is transmitted from respective antennas in the initial transmission. Then, when an error occurs in such multiple code words, only the code word in which an error is caused is retransmitted. In this case, the new code word is not transmitted with respect to the code word in which no error is caused. In this manner, the technology to not transmit the new code word but transmit only the code word in which an error is caused until the error is eliminated from all code words that are multiplexed in space is defined as the blanking.

When HARQ is employed in MCW that applis the adaptive modulation every code word as described above, CQI must be fed back every code word. Therefore, when the number of transmitted code words is increased, an increase in the total number of feedback bits is caused in the CQI feedback. For example, when the case of the transmission of 2 code words is considered, (5 bits)×(2 code words)=10 bits is needed in total in 2 code words under the assumption that one code word of CQI consists of 5 bits. Then, when the number of transmitted code words is increased, the number of CQI bits is increased by an integral multiple of the number of transmitted code words. Then, when feedback information is increased, an overhead in the reverse link that transmits the feedback information is increased, so that a frequency efficiency of the reverse link is lowered. For this reason, the CQI feedback whose overhead is small is demanded.

Non-Patent Literature 1: 3GPP TSG RAN WGI #44, R1-060459, QUALCOMM Europe, “Implications of MCW MIMO on DL HARQ”, February, 2006

### DISCLOSURE OF THE INVENTION

### Problems that the Invention is to Solve

As described above, in HARQ in MCW, CQI must be fed back every code word. Therefore, such a problem exists that, when the number of transmitted code words is increased, the total number of feedback bits in the CQI feedback is increased.

The present invention has been made in view of the above circumstances, and it is an object of the present invention to provide a radio communication apparatus, a radio communication system, and a radio communication method, capable of suppressing errors in feedback information while reducing an amount of information required for feedback every stream in the data transmission such as MCW, or the like using multiple streams.

### Means for Solving the Problems

According to a first aspect of the present invention, there is provided a radio communication apparatus for performing data transmission by multiple code words in multiple streams and blanking transmission of retransmitting the code words to a communication partner station only in an superior stream, a received quality of which is excellent, out of the multiple streams in retransmitting the code words, the radio communication apparatus comprising: a response signal generator which generates a response signal in response to a received result of the code words being transmitted from the communication partner station in the multiple streams; a received quality information generator which generates received quality information indicating a received quality of each stream of the multiple streams; a resource allocation controller which controls a resource allocation of the received quality information, and changes the resource allocation of the received quality information between the multiple streams when a Nack signal is detected as the response signal; and a feedback information transmitter which transmits feedback information containing the response signal and the received quality information to the communication partner station.

Accordingly, an amount of information required for the feedback every stream in the data transmission using multiple streams can be reduced by controlling the resource allocation of the received quality information. In this case, when the Nack signal is detected, the resource allocation is changed. Therefore, occurrence of the error of the received quality caused due to the information compression from the essentially required received quality can be suppressed while suppressing a total amount of the feedback information, and as a result the performance degradation can be prevented.

A second aspect of the present invention includes the radio communication apparatus, wherein, when the Nack signal is not detected, the resource allocation controller controls the resource allocation such that a resource in the superior stream out of the multiple streams is decreased in the received quality information that is to be notified before transmission to which the blanking transmission is not applied.

Accordingly, the resource in the superior stream in which a variation of the received quality is small is reduced. Therefore, an amount of information can be reduced without occurrence of the error in the feedback information.

A third aspect of the present invention includes the radio communication apparatus according to the first aspect of the present invention, wherein, when the Nack signal is detected, the resource allocation controller controls the resource allocation such that a resource in the superior stream out of the multiple streams is increased in the received quality information that is to be notified before transmission to which the blanking transmission is applied.

Accordingly, the resource of the received quality information in the superior stream required for the blanking transmission is increased. Therefore, the high-precision received quality information can be fed back by suppressing occurrence of the error in the received quality information caused due to a big variation of the propagation paths condition while suppressing a total amount of the feedback information, and as a result the performance degradation can be prevented.

A fourth aspect of the present invention includes the radio communication apparatus according to the first aspect of the present invention, wherein, when the Nack signal is not detected, the resource allocation controller controls the resource allocation such that a resource in the inferior stream out of the multiple streams is increased larger than a resource in the superior stream in the received quality information that is notified before transmission to which the blanking transmission is not applied.

Accordingly, when the blanking transmission is not executed, the resource in the inferior stream is increased larger than the resource in the superior stream. Therefore, in the situation that a variation of the received quality is small like the superior stream and the error of the received quality information is not caused, an amount of information can be reduced by reducing the resource of the feedback information.

A fifth aspect of the present invention includes the radio communication apparatus according to the first aspect of the present invention, wherein, in such a situation that data transmission using four streams as the multiple streams is performed, when the Nack signal is detected, the resource allocation controller controls the resource allocation such that a resource in two superior streams out of four streams is increased in the received quality information that is to be notified before transmission to which the blanking transmission is applied.

Accordingly, in the four stream transmission, occurrence of the error in the received quality information caused due to the big variation of the propagation paths condition can also be suppressed while suppressing a total amount of the feedback information in the blanking transmission, and as a result the performance degradation can be prevented.

A sixth aspect of the present invention includes the radio communication apparatus according to the third aspect of the present invention, wherein the resource allocation controller controls the resource allocation such that, when the Nack signal is caused from the code words being transmitted in the superior stream out of the multiple streams, a resource in the superior stream is increased, and also controls the resource allocation such that, when the Nack signal is caused from the code words being transmitted in the inferior stream out of the multiple streams, a resource in the superior stream is decreased.

Accordingly, occurrence of the error in the received quality information caused due to the big variation of the propagation paths condition can also be suppressed while suppressing a total amount of the feedback information, and as a result the performance degradation can be prevented. Also, the resource allocation can be changed in response to in which one of the superior stream and the inferior stream the Nack signal is caused, and thus an amount of information can be reduced further more.

A seventh aspect of the present invention includes the radio communication apparatus according to the sixth aspect of the present invention, wherein, when the Nack signal is caused from the code words being transmitted in the inferior stream, the feedback information transmitter add information indicating to what extent the code words being transmitted in the inferior stream is mistaken in the feedback information.

Accordingly, the communication partner station can know an amount of data required for the retransmission, by the information indicating to what extent the code word is mistaken. Therefore, the resources associated with the data transmission can be utilized effectively.

According to an eighth aspect of the present invention, there is provided a radio communication apparatus for performing data transmission by multiple code words in multiple streams and blanking transmission for retransmitting the code words to a communication partner station only in an superior stream, a received quality of which is excellent, out of the multiple streams in retransmitting the code words, the radio communication apparatus comprising: a feedback information receiver which receives feedback information from the communication partner station; a response signal extractor which extracts a response signal that responds to a received result of the code words contained in the feedback information; a resource allocation deciding section which decides a resource allocation of received quality information contained in the feedback information, in response to whether or not a Nack signal is caused as the response signal; a received quality reproducing section which reproduces a received quality of each stream out of the multiple streams from the received quality information, based on the resource allocation; and an adaptive controller which applies an adaptive control of the code words being transmitted in the multiple streams, based on the received quality.

Accordingly, occurrence of the error of the received quality caused due to the information compression from the essentially required received quality can be suppressed while suppressing a total amount of the feedback information, and as a result the performance degradation can be prevented.

A ninth aspect of the present invention includes the radio communication apparatus according to the eighth aspect of the present invention, wherein, when the Nack signal is not detected, the resource allocation deciding section decides the resource allocation such that a resource in the superior stream out of the multiple streams is decreased, and the adaptive controller applies the adaptive control by using the received quality being reproduced based on the resource allocation, and performs normal transmission to which the blanking transmission is not applied.

Accordingly, the resource in the superior stream in which a variation of the received quality is small is reduced. Therefore, an amount of information can be reduced without occurrence of the error in the feedback information.

A tenth aspect of the present invention includes the radio communication apparatus according to the eighth aspect of the present invention, wherein, when the Nack signal is detected, the resource allocation deciding section decides the resource allocation such that a resource in the superior stream out of the multiple streams is increased, and the adaptive controller applies the adaptive control by using the received quality being reproduced based on the resource allocation, and performs the blanking transmission by using the superior stream.

Accordingly, the resource of the received quality information in the superior stream required for the blanking transmission is increased. Therefore, the high-precision received quality information can be fed back by suppressing occurrence of the error in the received quality information caused due to a big variation of the propagation paths condition while suppressing a total amount of the feedback information, and as a result the performance degradation can be prevented.

An eleventh aspect of the present invention includes the radio communication apparatus according to the eighth aspect of the present invention, wherein, when the Nack signal is not detected, the resource allocation deciding section decides the resource allocation such that a resource in the inferior stream out of the multiple streams is increased larger than a resource in the superior stream, and the adaptive controller applies the adaptive control by using the received quality being reproduced based on the resource allocation, and performs normal transmission to which the blanking transmission is not applied.

Accordingly, when the blanking transmission is not executed, the resource in the inferior stream is increased larger than the resource in the superior stream. Therefore, in the situation that a variation of the received quality is small like the superior stream and the error of the received quality information is not caused, an amount of information can be reduced by reducing the resource of the feedback information.

A twelfth aspect of the present invention includes the radio communication apparatus according to the eighth aspect of the present invention, wherein, in such a situation that data transmission using four streams as the multiple streams is performed, when the Nack signal is detected, the resource allocation deciding section decides the resource allocation such that a resource in two superior streams out of four streams is increased, and the adaptive controller applies the adaptive control by using the received quality being reproduced based on the resource allocation, and performs the blanking transmission by using the two superior streams.

Accordingly, in the four stream transmission, occurrence of the error in the received quality information caused due to the big variation of the propagation paths condition can also be suppressed while suppressing a total amount of the feedback information in the blanking transmission, and as a result the performance degradation can be prevented.

A thirteenth aspect of the present invention includes the radio communication apparatus according to the tenth aspect of the present invention, wherein the resource allocation deciding section decides the resource allocation such that, when the Nack signal is caused from the code words being transmitted in the superior stream out of the multiple streams, a resource in the superior stream is increased, and also decides the resource allocation such that, when the Nack signal is caused from the code words being transmitted in the inferior stream out of the multiple streams, a resource in the superior stream is decreased, and the adaptive controller applies the adaptive control by using the received quality being reproduced based on the resource allocation, and performs the blanking transmission by using the superior stream.

Accordingly, occurrence of the error in the received quality information caused due to the big variation of the propagation paths condition can also be suppressed while suppressing a total amount of the feedback information, and as a result the performance degradation can be prevented. Also, the resource allocation can be changed in response to in which one of the superior stream and the inferior stream the Nack signal is caused, and thus an amount of information can be reduced much more.

The present invention also provides a radio communication base station equipment equipped with the radio communication apparatus in any one of the first aspect to thirteenth aspect.

The present invention also provides a radio communication mobile station equipment equipped with the radio communication apparatus in any one of the first aspect to thirteenth aspect.

The present invention also provides a radio communication system for performing data transmission by multiple code words in multiple streams and blanking transmission of retransmitting the code words to a communication partner station only in an superior stream, a received quality of which is excellent, out of the multiple streams in retransmitting the code words, the radio communication system comprising: a receiving apparatus including: a response signal generator which generates a response signal in response to a received result of the code words being transmitted from a transmitting apparatus in the multiple streams; a received quality information generator which generates received quality information indicating a received quality of each stream of the multiple streams; a resource allocation controller which controls a resource allocation of the received quality information, and changes the resource allocation of the received quality information between the multiple streams when a Nack signal is detected as the response signal; and a feedback information transmitter which transmits feedback information containing the response signal and the received quality information to the communication partner station; and a transmitting apparatus including: a feedback information receiver which receives feedback information from the receiving apparatus; a response signal extractor which extracts a response signal that responds to a received result of the code words contained in the feedback information; a resource allocation deciding section which decides a resource allocation of received quality information contained in the feedback information, in response to whether or not a Nack signal is caused as the response signal; a received quality reproducing section which reproduces a received quality of each stream out of the multiple streams from the received quality information, based on the resource allocation; and an adaptive controller which applies an adaptive control of the code words being transmitted in the multiple streams, based on the received quality

The present invention also provides a radio communication method applied in a radio communication apparatus for performing a data transmission held by multiple code words in multiple streams and blanking transmission for retransmitting the code words to a communication partner station only in an superior stream, a received quality of which is excellent, out of the multiple streams in retransmitting the code words, the radio communication method comprising: generating a response signal in response to a received result of the code words being transmitted from the communication partner station in the multiple streams; generating received quality information indicating a received quality of each stream of the multiple streams; controlling a resource allocation of the received quality information, and changing the resource allocation of the received quality information between the multiple streams when a Nack signal is detected as the response signal; and transmitting feedback information containing the response signal and the received quality information to the communication partner station.

The present invention also provides a radio communication method applied in a radio communication apparatus for performing data transmission by multiple code words in multiple streams and blanking transmission for retransmitting the code words to a communication partner station only in an superior stream, a received quality of which is excellent, out of the multiple streams in retransmitting the code words, the radio communication method comprising: receiving feedback information from the communication partner station; extracting a response signal that responds to a received result of the code words contained in the feedback information; deciding a resource allocation of received quality information contained in the feedback information, in response to whether or not a Nack signal is caused as the response signal; reproducing a received quality of each stream out of the multiple streams from the received quality information, based on the resource allocation; and applying an adaptive control of the code words being transmitted in the multiple streams, based on the received quality.

### ADVANTAGES OF THE INVENTION

According to the radio communication apparatus, the radio communication system, and the radio communication method according to the present invention, errors in feedback information can be suppressed while reducing an amount of information required for the feedback every stream in the data transmission such as MCW, or the like using multiple streams.

### BRIEF DESCRIPTION OF THE DRAWINGS

FIG. 1 shows a variation in received quality in time upon transmitting two streams.

FIG. 2 shows an absolute value CQI table employed in the present embodiment.

FIG. 3 shows a relative value CQI table employed in the present embodiment.

FIG. 4 shows an example of the feedback bit number of CQI in a first embodiment of the present invention.

FIG. 5 is a block diagram showing a configuration of a receiving apparatus of the first embodiment.

FIG. 6 is a block diagram showing a configuration of a transmitting apparatus of the first embodiment.

FIG. 7 shows a process sequence in the first embodiment.

FIG. 8 shows a process flow in the receiving apparatus of the first embodiment.

FIG. 9 shows a process flow in the transmitting apparatus of the first embodiment.

FIG. 10 shows an error of CQI when a big variation of received quality in time occurs.

FIG. 11 is a conceptual view of a transmitting method applied when two stream transmission is made.

FIG. 12 shows an error occurring probability when two code words are transmitted in two streams.

FIG. 13 shows an example of the feedback bit number of CQI in a second embodiment of the present invention.

FIG. 14 is a block diagram showing a configuration of a receiving apparatus of the second embodiment.

FIG. 15 is a block diagram showing a configuration of a transmitting apparatus of the second embodiment.

FIG. 16 shows a process sequence in the second embodiment.

FIG. 17 shows a process flow in the receiving apparatus of the second embodiment.

FIG. 18 shows a process flow in the transmitting apparatus of the second embodiment.

FIG. 19 shows an error occurring probability when four code words are transmitted in four streams.

FIG. 20 shows an example of the feedback bit number of CQI upon transmitting four streams in a variation of the second embodiment.

FIG. 21 shows an example of the feedback bit number of CQI in a third embodiment of the present invention.

FIG. 22 is a block diagram showing a configuration of a receiving apparatus of the third embodiment.

FIG. 23 is a block diagram showing a configuration of a transmitting apparatus of the third embodiment.

FIG. 24 shows a process flow in the receiving apparatus of the third embodiment.

FIG. 25 shows a process flow in the transmitting apparatus of the third embodiment.

FIG. 26 shows a behavior when the ranking level of the stream is changed.

FIG. 27 shows an example of the feedback bit number of CQI in a fourth embodiment of the present invention.

FIG. 28 is a block diagram showing a configuration of a receiving apparatus of the fourth embodiment.

FIG. 29 is a block diagram showing a configuration of a transmitting apparatus of the fourth embodiment.

FIG. 30 shows a process flow in the receiving apparatus of the fourth embodiment.

FIG. 31 shows a process flow in the transmitting apparatus of the fourth embodiment.

### DESCRIPTION OF REFERENCE NUMERALS

500, 1400, 2200, 2800 receiving apparatus

501, 502 antenna

503 MIMO receiver

504 channel estimator

505 received quality estimator

506 stream ranking section

507 ranking information generator

509, 1409, 2209, 2809 CQI bit number allocation deciding section

510, 1410, 2210, 2810 feedback CQI information generator

511, 1411, 2211, 2811 feedback information transmitter

1408 Nack detector

2208 CW rank-specific Nack detector

2808 stream rank change detector

600, 1500, 2300, 2900 transmitting apparatus

601 transmission signal generator

602 MIMO transmitter

603, 604 antenna

605 feedback information receiver

607 CQI information extractor

608 ranking information extractor

609, 1509, 2309, 2909 CQI bit number allocation deciding section

610, 1510, 2310, 2910 CQI reproducing section

611, 1511, 2311, 2911 adaptive controller

1506 Nack extractor

2306 CW rank-specific Nack extractor

2906 stream rank change detector

### BEST MODE FOR CARRYING OUT THE INVENTION

Embodiments of the present invention will be explained with reference to the drawings hereinafter.

In the present embodiments, as an example of the radio communication apparatus, the radio communication system, and the radio communication method according to the present invention, such a configurative example is illustrated that both the transmitting apparatus and the receiving apparatus in the radio communication system employing MIMO make a signal transmission with multiple antennas while using multiple code words (CW) in multiple streams, and apply a retransmission control (adaptive retransmission control) using HARQ in MCW. The code word denotes the data sequence as a control unit of MCS. Here, such a case is assumed that, in the cellular system, a signal (stream) is transmitted from a base station to a user equipment and then CQI is fed back as a received quality from the user equipment to the base station. In this case, the base station serves as a transmitting apparatus (transmitting station), and the user equipment serves as a receiving apparatus (receiving station). Here, following embodiments are given merely as examples for explanation purposes, and the present invention is not limited to these embodiments.

### First Embodiment

First, as the first embodiment, a configuration capable of reducing an amount of information upon feeding back CQI every code word in MCW will be explained hereunder. In order to reduce an amount of information in feeding back CQI, it may be considered that, when multiple streams are transmitted, the total number of feedback bits should be reduced by using a correlation between CQIs in respective streams in a variation in time. As the method applied in this case, for example, the method of reducing the total bit number by such a manner that an absolute value of CQI is fed back in advance and then a relative value to the CQI being fed back precedingly (difference information) is notified subsequently in smaller number of bits than the bit numbers of the above absolute value, and the like may be considered.

Also, there is such a feature that, when the ranking process (or the ordering process) of ranking respective streams based on a received quality is applied upon transmitting multiple streams, the fading variation is limited to a gentle variation in the superior stream after the ranking is applied and also an amount of change with respect to the amount of time elapsed is decreased. Therefore, when this feature of the superior stream is applied to the method of feeding back CQI by using the above relative value, the number of feedback bits of CQI can be reduced.

In the present embodiments, the ranking is performed based on the received quality, then the absolute value of CQI is reported in advance in the CQI feedback of the superior stream, and then the relative value to the CQI being reported precedingly is reported subsequently in smaller number of bits than the bit numbers of the absolute value of CQI. As a result, the total number of feedback bits of CQI is reduced. Here, the case of the 2-stream transmission is explained as an example.

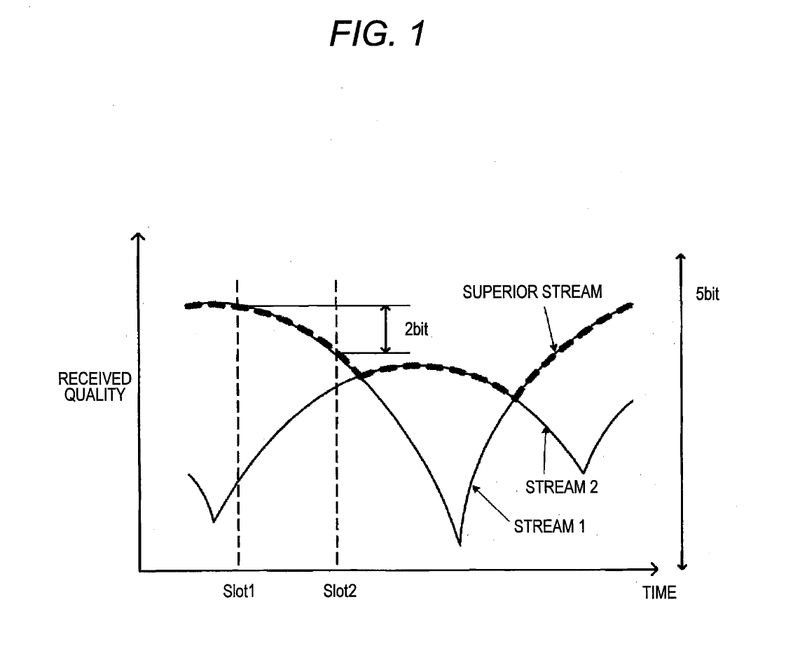

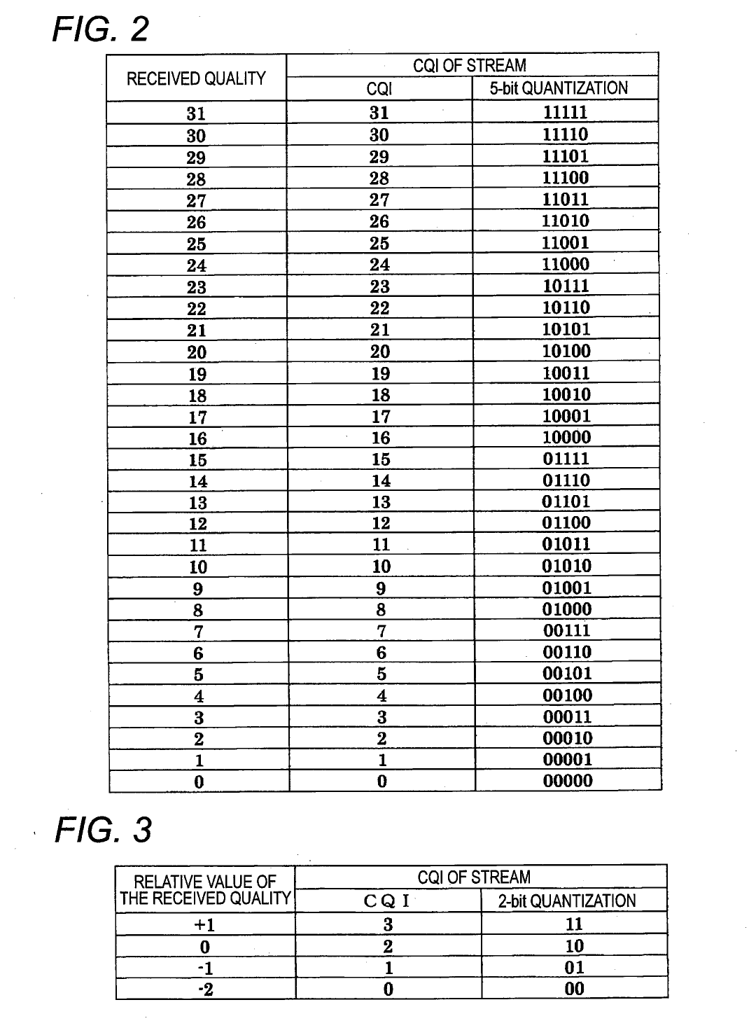

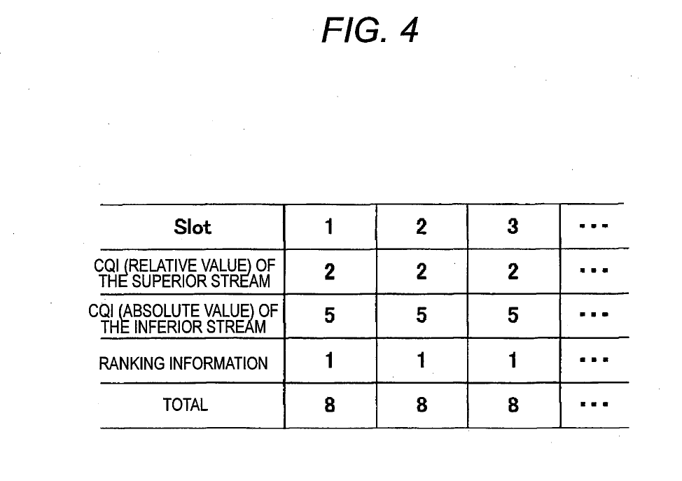

FIG. 1 shows a variation in received quality in time upon transmitting two streams, FIG. 2 shows an absolute value CQI table employed in the present embodiment, FIG. 3 shows a relative value CQI table employed in the present embodiment, and FIG. 4 shows an example of the feedback bit number of CQI in a first embodiment of the present invention.

In FIG. 1, the received qualities of a stream 1 and a stream 2 are illustrated with graphs, and the superior stream is indicated with a thick broken line. As the received quality, for example, a received SINR (Signal to Interference and Noise Ratio) and the like is considered. Here, when the ranking (ordering) is applied to the streams based on the received quality, the received quality of the superior stream is indicated with a thick broken line. In contrast, thin lines showing the received qualities of the stream 1 and the stream 2 that do not correspond to the superior stream indicate the received quality of the inferior streams.

Here, as a dynamic range of CQI to the received quality, about 30 dB is needed to be applied to the cellular environment from the neighborhood of the base station to the cell edge, so that the dynamic range is given by 30 steps under the assumption that 1 dB corresponds to one step. Therefore, 5 bits are needed as the bit number representing the CQI. The CQI represented by 5 bits is assumed as the absolute value CQI. For example, an absolute value CQI table shown in FIG. 2 can be employed in connection with the CQI bit in the absolute value CQI with respect to the received quality. In FIG. 2, for example, in the case where the received quality is “25”, when “11001” that is a 5-bit quantized value is fed back as the CQI bit from the receiver side, the received quality of “25” is reproduced on the transmitter side by employing the table in FIG. 2, which is the same as the table on the receiver side.

In contrast, a range of a variation in received quality of the superior stream is smaller than the dynamic range of the absolute value CGI, and thus a dynamic range required for covering this variation becomes narrow. Therefore, when a relative value of the CQI (relative value CQI) as a difference information from the precedingly reported CQI is reported in smaller number of bits than the bit number of the absolute value of CQI, the total number of feedback bits of CQI can be reduced. For example, a relative value CQI table shown in FIG. 3 representing the relative value CQI by 2 bits can be employed. For example, in the case where the current received quality is “−1” in contrast to the received quality (CQI) reported precedingly, when the receiver side feeds back “01”, which is the 2-quantized value, as the CQI bit, the transmitter side can reproduce the received quality by using the same table as that shown in FIG. 3 and the preceding CQI.

Then, when the feedback period of CQI is given in unit of slot, the number of feedback bits of CQI when CQI is represented by the absolute value and the relative value as above is shown in FIG. 4. As shown in FIG. 4, when 2 bits (relative value), 5 bits (absolute value), and 1 bit are allocated to the superior stream, the inferior stream, and the ranking information indicating the superior or inferior stream in each slot respectively, 8 bits are required in total. In this case, the number of feedback bits can be reduced in contrast to the case where the absolute value (5 bits) of CQI is fed back by two streams (5×2=10 bits) respectively.

A concrete operation will be explained as follows. First, the user equipment serving as the receiving apparatus reports the absolute value of CQI of each stream in advance to the base station serving as the transmitting apparatus. Then, the user equipment ranks the streams based on the received quality of each stream. In the superior stream, the relative value (difference) to the precedingly reported CQI is calculated. Also, in the inferior stream, the absolute value of CQI is calculated. Then, the user equipment reports the ranking information, the relative value CQI of the superior stream, and the absolute value CQI of the inferior stream to the base station. Then, the base station reproduces the CQIs of respective streams based on the reported information. An amount of information of the CQI feedback can be reduced by employing such method.

In this case, in addition to the above feedback information amount reducing method, following methods can be applied. For example, there are a method of reporting the absolute value of CQI in advance and then employing the absolute value of the narrow dynamic range that is set based on a reference value decided by this absolute value, a method of reporting the value that is obtained by applying a decimation process in a time direction and then interpolating the feedback information in a time direction, and the like.

Also, as the method of reporting the absolute value in advance, the method of feeding back the absolute value CQI of each stream in the same slot only in the first feedback, the method of feeding back the absolute value CQI on a time (slot) division basis, and the like may be considered.

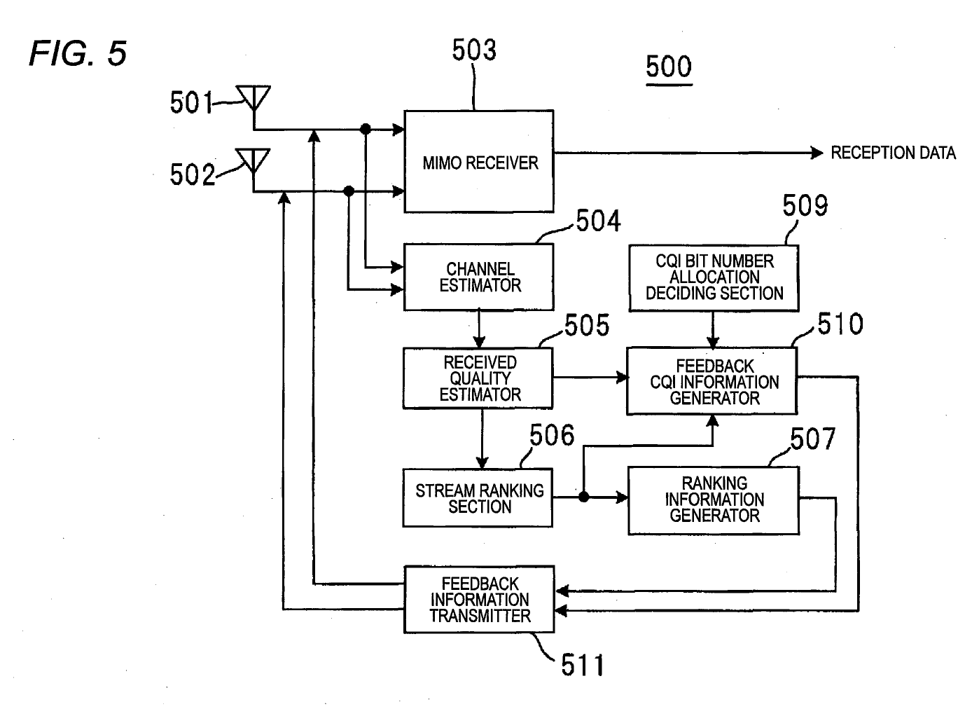

Next, a concrete configurative example of the radio communication apparatus according to the first embodiment is illustrated hereunder. FIG. 5 is a block diagram showing a configuration of a receiving apparatus of the first embodiment. A receiving apparatus 500 includes antennas 501, 502, a MIMO receiver 503, a channel estimator 504, a received quality estimator 505, a stream ranking section 506, a ranking information generator 507, a CQI bit number allocation deciding section 509, a feedback CQI information generator 510, and a feedback information transmitter 511.

The receiving apparatus 500 receives the signals of multiple streams (here, two streams) being MIMO-transmitted (SDM-transmitted) from the transmitting apparatus of the communication partner station via the antennas 501, 502. Then, the MIMO receiver 503 obtains the received data in multiple code words by applying the receiving processes such as the demodulation process, the decoding process, etc. to the received signals. The MIMO receiver 503 is not particularly limited if it can receive the SDM-transmitted signal. For example, there are a receiving method using the filtering such as Zero Forcing, MMSE (Minimum Mean Square Error), or the like, a receiving method using SIC (Successive Interference Canceller), or the like, etc.

The channel estimator 504 executes the channel estimation of each stream in multiple streams by using a pilot signal in the received signal. The received quality estimator 505 estimates the received quality of each stream by using the channel estimation value estimated by the channel estimator 504. As the received quality, the received SINR, and the like are considered.

The stream ranking section 506 decides the ranking level by using the estimated received quality of each stream in order of excellence in the received quality of the stream. The ranking information generator 507 generates the ranking information by using the ranking level decided by the stream ranking section 506.

When the CQI is to be fed back as received quality information indicating the above estimated received quality, the CQI bit number allocation deciding section 509 decides the allocation of the CQI bit number between the streams as the resource allocation of this received quality information. In the present embodiment, the CQI bit number allocation deciding section 509 decides the allocation of the CQI bit number based on the ranking level of the stream such that the bit number should be decreased in the superior stream and the bit number should be increased in the inferior stream.

The feedback CQI information generator 510 generates feedback CQI information from the received quality of each stream, which is estimated by the received quality estimator 505, in response to the CQI bit number that is decided by the CQI bit number allocation deciding section 509 based on the ranking level of each stream decided by the stream ranking section 506.

The feedback information transmitter 511 executes the transmitting process to feed back the feedback information, which contains Ack (Acknowledgement)/Nack (Negative Acknowledgement) information indicating whether each stream is received or not, and the generated CQI information and ranking information, to the transmitting apparatus.

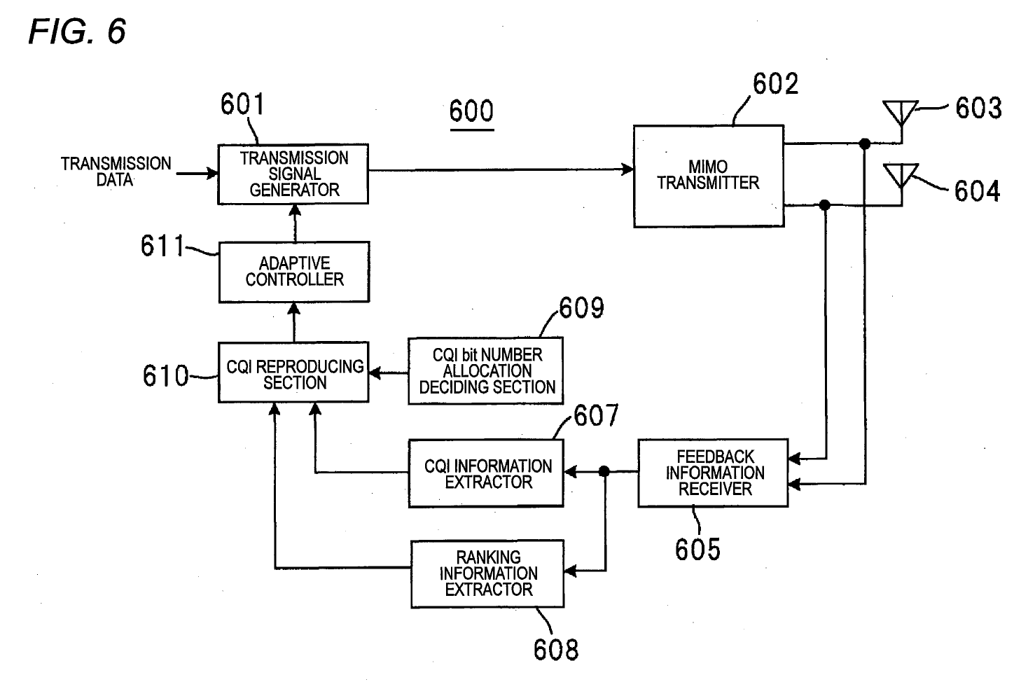

FIG. 6 is a block diagram showing a configuration of a transmitting apparatus of the first embodiment. A transmitting apparatus 600 includes a transmission signal generator 601, a MIMO transmitter 602, antennas 603, 604, a feedback information receiver 605, a CQI information extractor 607, a ranking information extractor 608, a CQI bit number allocation deciding section 609, a CQI reproducing section 610, and an adaptive controller 611.

In the transmitting apparatus 600, the transmission signal generator 601 generates the transmission signal by applying the coding process and the modulation process to the transmission data while using a modulation system and a coding ratio being decided by the adaptive controller 611. The MIMO transmitter 602 MIMO-transmits (SDM-transmits) multiple code words in multiple streams (here, two streams) to the receiving apparatus of the communication partner station based on the generated transmission signal via the antennas 603, 604. The MIMO transmitter 602 is not particularly limited if it can SDM-transmit multiple code words. For example, there are a method of transmitting respective code words from respective antennas, a method of transmitting respective code words that are multiplied by a transmission weight respectively from respective antennas, etc.

The feedback information receiver 605 executes the receiving process of the feedback information fed from the receiving apparatus. The CQI information extractor 607 extracts the CQI information as the received quality information from the feedback information. The ranking information extractor 608 extracts the ranking information of each stream from the feedback information.

The CQI bit number allocation deciding section 609 decides the allocation of the CQI bit number between the streams as the resource allocation of the received quality information like the CQI bit number allocation deciding section 509 in the receiving apparatus 500. In the present embodiment, the CQI bit number allocation deciding section 609 decides the allocation of the CQI bit number based on the ranking level of the stream, and decides the allocation of the CQI bit number such that the bit number should be decreased in the superior stream and the bit number should be increased in the inferior stream.

The CQI reproducing section 610 reproduces the CQI indicating the received quality of each stream, by using the CQI information extracted by the CQI information extractor 607, the ranking information of each stream extracted by the ranking information extractor 608, and the CQI bit allocation of each stream decided by the CQI bit number allocation deciding section 609. The adaptive controller 611 controls the modulation system and the coding ratio of the transmission signal based on the reproduced CQI. Also, the adaptive controller 611 applies the retransmission control at a time of retransmission when the transmitting apparatus receives the Nack signal from the receiving apparatus.

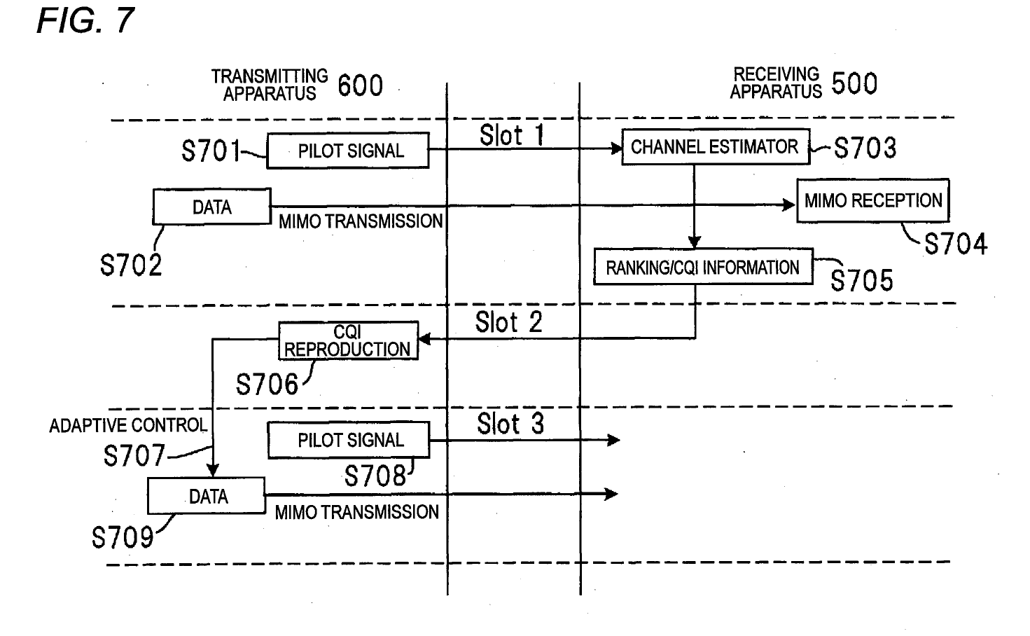

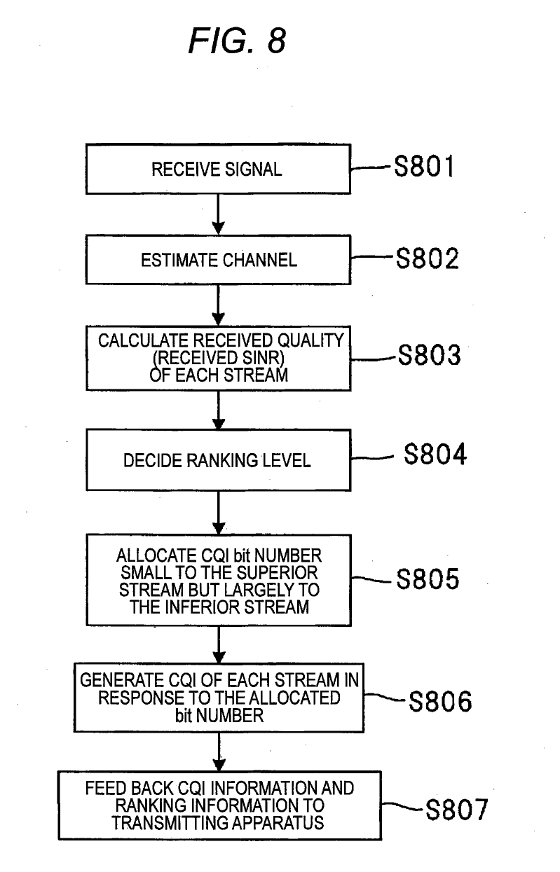

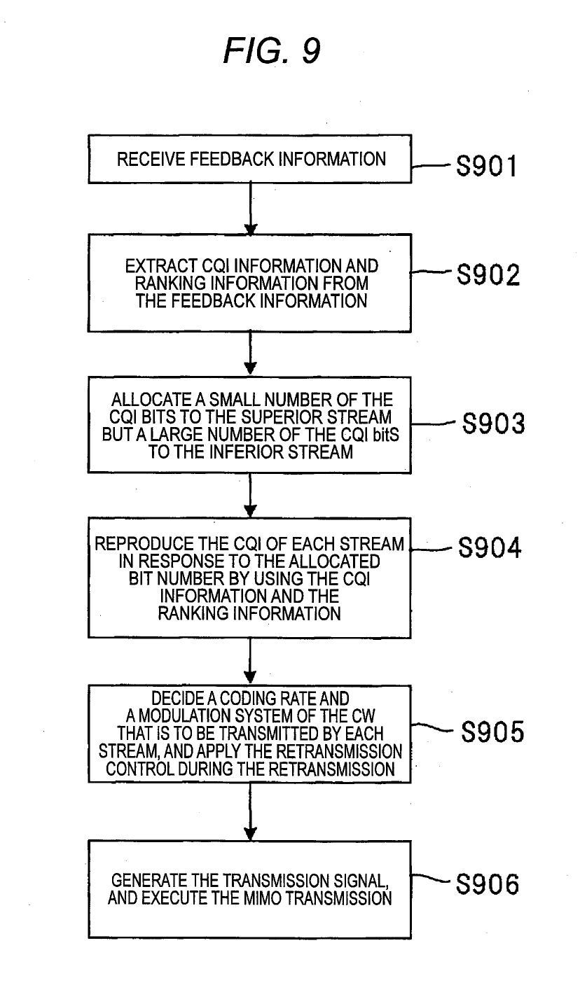

Next, a sequence and a flow of the process in the radio communication apparatus in the first embodiment will be explained hereunder. FIG. 7 shows a process sequence in the first embodiment, FIG. 8 shows a process flow in the receiving apparatus of the first embodiment, and FIG. 9 shows a process flow in the transmitting apparatus of the first embodiment.

A flow of a basic process will be explained by reference to the process sequence in FIG. 7 hereunder. Here, only the information associated with the present embodiment is illustrated. Successive slots (Slot 1, Slot 2, Slot 3) in the time slot are illustrated, but the slots are not limited to them.

First, in the slot 1 (Slot 1), the transmitting apparatus 600 transmits a pilot signal and data (S701, S702), and the receiving apparatus 500 receives them. At this time, the data of multiple code words (MCW) are transmitted in multiple streams. In the receiving apparatus 500, the channel estimation is executed by using the pilot signal (S703). Also, the received data is MIMO-received (S704), and the decoding process is applied every code word. Then, the ranking information and the CQI information of each stream are generated by using the channel estimation value (S705).

In the slot 2 (Slot 2), the receiving apparatus 500 feeds back the ranking information and the CQI information, which are generated on the receiver side in the slot 1, to the transmitting apparatus 600. In the transmitting apparatus 600, the CQI of each transmitted code word is reproduced from the ranking information and the CQI information that are fed back (S706).

In the slot 3 (Slot 3), in the transmitting apparatus 600, the adaptive control of MCS of the transmission data is applied based on the CQI of each code word being reproduced in the slot 2 (S707). Then, the pilot signal and the data are transmitted by repeating the processes in the slot 1 (S708, S709).

In turn, a process flow in the receiving apparatus will be explained in order by reference to FIG. 8 hereunder. In the receiving apparatus 500, the MIMO receiver 503 receives the signal being transmitted from the transmitting apparatus 600 (S801). Then, the channel estimator 504 estimates the channel by extracting the pilot signal from the signal received in step S801 (S802).

Then, the received quality estimator 505 calculates and estimates the received quality of each stream by using the channel estimation value estimated in step S802 (S803). Here, as the received quality, for example, SINR is considered. In addition, SNR (Signal to Noise Ratio), SIR (Signal to Interference Ratio), a received power, and the like are also considered. Then, the stream ranking section 506 decides the ranking level by ranking respective streams while using the received quality of each stream estimated in step S803 (S804).

Also, the CQI bit number allocation deciding section 509 decides the allocation of the CQI bit number between the streams such that the bit number should be decreased in the superior stream and the bit number should be increased in the inferior stream (S805).

Then, the feedback CQI information generator 510 generates the CQI information of each stream, in response to the received quality of each stream estimated in step S803, the ranking level decided in step S804, and the CQI bit number of each stream decided in step S805 (S806). Then, the feedback information transmitter 511 feeds back the CQI information and the ranking information to the transmitting apparatus 600 (S807).

A process flow in the transmitting apparatus will be explained in order by reference to FIG. 9 hereunder. In the transmitting apparatus 600, the feedback information receiver 605 receives the feedback information fed from the receiving apparatus 500 (S901). Then, the CQI information extractor 607 extracts the CQI information from the feedback information received in step S901, and the ranking information extractor 608 extracts the ranking information from the feedback information (S902).

Then, the CQI bit number allocation deciding section 609 decides the allocation of the CQI bit number between the streams such that the bit number should be decreased in the superior stream and the bit number should be increased in the inferior stream (S903). Then, the CQI reproducing section 610 reproduces the CQI of each stream in response to the allocation of the CQI bit number decided in step S903 by using the CQI information and the ranking information extracted in step S902 (S904).

Then, the adaptive controller 611 decides the coding rate and the modulation system of the code word that is to be transmitted in each stream, based on the CQI of each stream reproduced in step S904. Also, the adaptive controller 611 applies the retransmission control during the retransmission (S905). Then, the transmission signal generator 601 generates the transmission signal in compliance with the coding ratio and the modulation system of each code word decided in step S905, and the MIMO transmitter 602 executes the MIMO transmission (S906).

In this manner, according to the first embodiment, an amount of information of the CQI feedback can be reduced by reporting the CQI information in the superior stream by the relative value. Therefore, in the data transmission of MCW using multiple streams, an amount of information in feeding back the data every code word can be reduced even when the code words are increased. As a result, a reduction in the frequency utilization efficiency in the reverse link that is used to inform the feedback information can be prevented.

### Second Embodiment

Next, a configuration that is capable of suppressing occurrence of a CQI error, while reducing an amount of information in feeding back the CQI every code word in MCW will be explained hereunder.

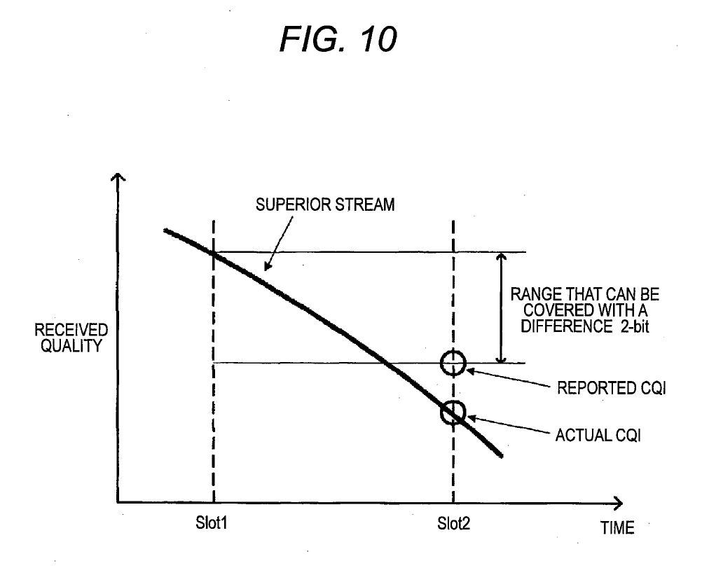

In the configuration of the above first embodiment, in a situation that a big variation occurs in the propagation path condition due to a shadowing variation, a sudden change in interference given by the adjacent cell, or the like, when the actual received quality in the superior stream exceeds a range that the relative value (difference information) can cover, an error is caused between the reported CQI information and the actual CQI, so that in some cases the performance are deteriorated. FIG. 10 shows an error of CQI when a big variation of received quality in time occurs.

Also, in the feedback information reducing method as explained in the first embodiment, when an error is caused in the decision of the fed-back relative value (difference information), such error is propagated to the subsequent CQI. Therefore, the error is contained in the CQI reported thereafter, and thus in some cases the performance are deteriorated. The method of reporting periodically the absolute value of CQI may be considered against such problem. In this method, however, a maximum amount of information must be kept as a format of the feedback information, and therefore it is unfeasible to compress an amount of information.

As described above, since an amount of information of the CQI is reduced by applying the information compression in the feedback of the CQI information, an error is caused between the essentially required CQI and the actual CQI, so that such a problem arises that the performance degradation is caused. For this reason, in the second embodiment, a CQI feedback method, which is capable of suppressing occurrence of a deviation from the essentially required CQI when the information compression is applied in the CQI feedback of MCW, and a configuration of the radio communication apparatus, to which this method is applied, are illustrated hereunder.

In the second embodiment, the bit number of the CQI feedback is allocated in response to the generation of Nack as one of the response signal that corresponds to the received result of the code word, and therefore the occurrence of a deviation from the essentially required CQI is suppressed while suppressing the total bit number of the CQI feedback, so that the performance degradation is prevented.

First, the CQI feedback necessary for the blanking process and the frequency of error occurrence in MCW, which are focusing points of the present embodiment, will be explained hereunder.

(1) CQI Feedback Necessary for the Blanking Process

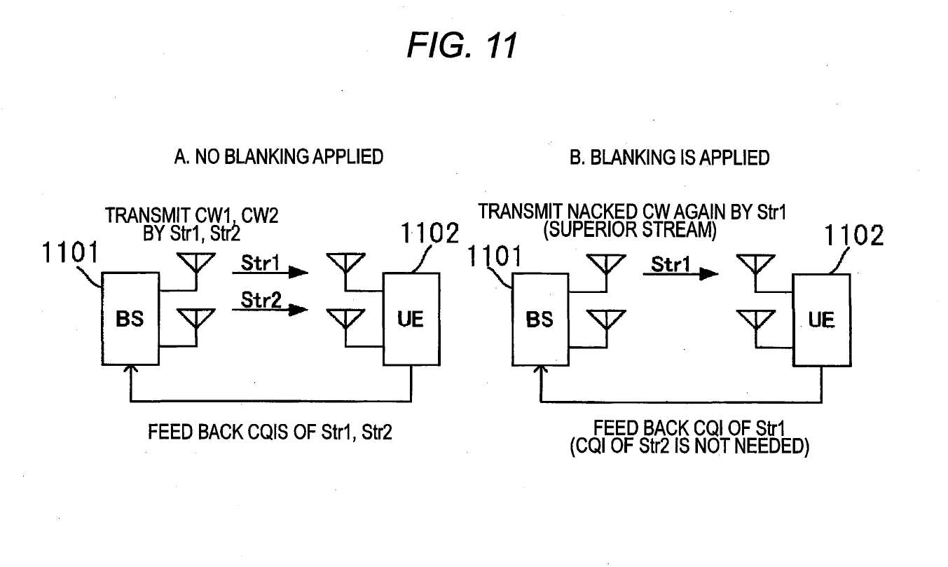

As one of the methods of HARQ in MCW, there is the blanking process. FIG. 11 is a conceptual view of a transmitting method applied when the two stream transmission is made. In FIG. 11, such processes are shown that two streams Str1, Str2 are transmitted from a base station (BS) 1101 serving as the transmitting apparatus to a user equipment (UE) 1102 serving as the receiving apparatus and the CQIs of respective streams are fed back from the user equipment 1102 to the base station 1101. Here, Str1 is assumed as the superior stream having good quality, and Str2 is assumed as the inferior stream having inferior quality.

In FIG. 11, A shows the case where the retransmission is not generated and no blanking applied. The new data are transmitted by the code words (CW1, CW2) in two streams respectively without blanking. In FIG. 11, B shows the case where one stream contains the receiving error and the transmitted stream is decided as Nack, and thus the retransmission is generated and the blanking is applied. In the blanking process, only the code word (CW) which is decided as Nack and whose retransmission is requested may be transmitted. Therefore, regardless of the streams used in the first transmission, the code word is retransmitted from the superior stream (here, Str1) whose quality is good, and the transmission of the inferior stream is not executed, so that the retransmission quality can be ensured. In this case, only the CQI of the superior stream is fed back from the user equipment 1102 to the base station 1101. In the blanking process, the CQI is not required for the stream to which the blanking is applied, i.e., the stream through which the code word is not transmitted (here, Str2), and thus there is no necessity to feed back the CQI.

(2) Frequency of Error Occurrence in MCW

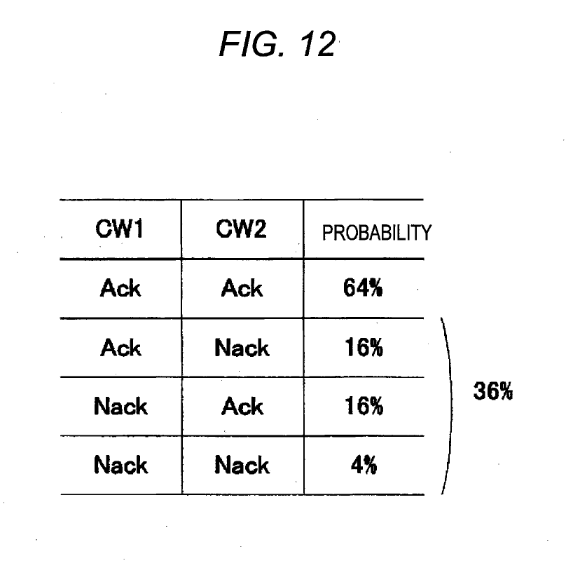

In the communication system in which HARQ is assumed, it is common that a target error rate per code word is set to several tens %. Therefore, in MCW employing multiple code words, an error rate of each code word is an independent event and thus a frequency of occurrence of the event that at least one code word is mistaken is high. FIG. 12 shows an error occurring probability when two code words are transmitted in two streams. For example, when a target PER (Packet Error Rate) is set to 20%, an error occurring probability in transmitting two streams (two code words) is given by 36% that is derived by adding respective probabilities that one code word or more are decided as Nack.

As described in the above (1), in the blanking transmission, there is no necessity that the CQI of the inferior stream as the stream to which the blanking is applied should be fed back. Also, as described in the above (2), an event in which Nack is caused such that the blanking transmission is needed occurs at a high frequency. In light of these two respects, the present embodiment includes following functions.

The event that Nack has been caused by the receiving error is detected by the user equipment serving as the receiving apparatus. Therefore, the user equipment can forecast that the blanking transmission is made from the base station serving as the transmitting apparatus in the retransmission. For this reason, in the present embodiment, a function of changing the bit allocation of CQI between multiple streams in the CQI feedback from the receiving apparatus, in which Nack is caused and which undergoes the blanking transmission, to the transmitting apparatus is provided.

For example, in the normal transmission without the blanking transmission, the superior stream reports the relative value (2 bits) of CQI and the inferior stream reports the absolute value (5 bits) of CQI, like the first embodiment. In contrast, when the blanking transmission is to be executed, the bit allocation of CQI between the streams is changed and the absolute value (5 bits) of CQI in the superior stream is reported. As a result, the absolute value of CQI in the superior stream can be reported without an increase in the feedback bit number.

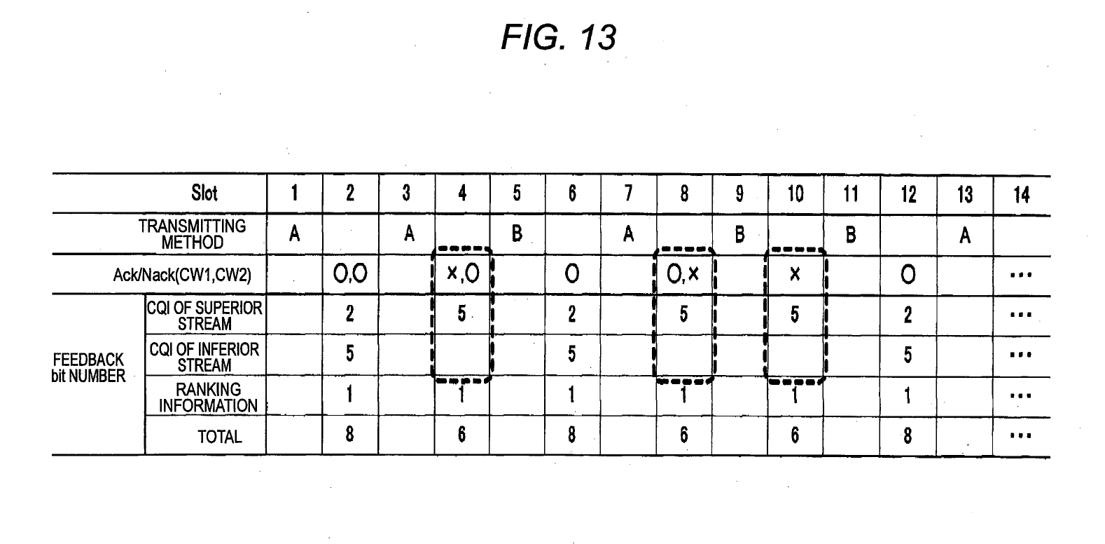

Next, a concrete method of allocating the CQI bit number in the second embodiment will be illustrated hereunder. FIG. 13 shows an example of the feedback bit number of CQI in the second embodiment of the present invention. In FIG. 13, “Slot” indicates the slot number, and the “transmitting method” indicates the transmitting methods A and B in FIG. 11, where A indicates the transmission to which no blanking is applied and B indicates the transmission to which the blanking is applied. Also, “Ack/Nack” denotes Ack/Nack of each code word (CW1, CW2), and o indicates Ack and x indicates Nack. The “feedback bit number” denotes the bit number that is fed back by the concerned slot. Also, in an example in FIG. 13, one slot contains procedures required until the receiver side receives the code words transmitted from the transmitter side, then makes an error decision, and then feeds back Ack/Nack and CQI. Then, the transmitter side executes the retranssmitting process based on the Ack/Nack and CQI fed back from the receiver side. Here, even when the number of slots required until the feedback is made after the receiver side executes the receiving process is larger than one slot, no problem arises. The processes executed every slot will be explained hereunder.

[Slot 1]

The transmitter side transmits CW1 by the superior stream and transmits CW2 by the inferior stream. The receiver side executes the receiving process, and decides whether or not an error is caused in CW1, CW2. As the error decision, the error decision made by using CRC (Cyclic Redundant Code) is common. No error is caused in both CW1 and CW2.

[Slot 2]

The Ack/Nack information of each code word transmitted in the slot 1 and the CQI information of each stream to be employed in the code word transmitted in the slot 3 are fed back from the receiver side to the transmitter side. The receiver side reports Ack of CW1 and CW2 transmitted in the slot 1, the relative value (difference information) of CQI of the inferior stream, and the absolute value of CQI of the inferior stream to the transmitter side.

[Slot 3]

The transmitter side can appreciate that no error is caused in CW1, CW2 transmitted in the slot 1, based on the Ack/Nack information being fed back in the slot 2. Therefore, the transmitter side transmits the new CW1, CW2. The receiver side decides whether or not an error is caused in CW1, CW2. Here, the error is caused in CW1.

[Slot 4]

The receiver side reports Nack of CW1, Ack of CW2, and the absolute value of CQI of the superior stream, which are transmitted in the slot 3, to the transmitter side.

[Slot 5]

The transmitter side can appreciate that the error is caused in CW1 transmitted in the slot 3, based on the Ack/Nack information being fed back in the slot 4. Therefore, the transmitter side executes the blanking and transmits CW1 again from the superior stream. Here, as the retransmitting method, there are the retransmitting method employed in HSDPA (High Speed Downlink Packet Access) of 3GPP, and the like. In this case, since CQI of the superior stream has already been fed back, the retransmission data may be generated adaptively based on the received quality indicated by CQI and then may be transmitted. The receiver side executes the receiving process by synthesizing the CW1 transmitted in the slot 3 and the retransmitted CW1, and makes the error decision. Here, no error is caused in CW1.

[Slot 6]

The receiver side reports Ack of CW1, the relative value (difference information) of CQI of the superior stream, and the absolute value of CQI of the inferior stream, which are retransmitted in the slot 5, to the transmitter side.

[Slot 7]

In the slot 7 and after this slot, the similar processes to those from the slot 1 to the slot 6 are executed.

In the case of an example in FIG. 13, the slots 4, 8, 10 correspond to the slot that feeds back Nack when the error is caused in the transmitted CW. In the slots 5, 9, 11 subsequent to these slots, the blanking transmission is executed by the transmitting method B, or the like in FIG. 11, and only the CW in which Nack is generated is retransmitted by the superior stream. Since the CW is transmitted only by the superior stream in this blanking transmission, CQI of the inferior stream is not needed. Therefore, in the CQI feedback in the slots (slots 4, 8, 10) before the blanking transmission is made, only the absolute value of CQI of the superior stream is reported. As a result, the absolute value of CQI of the superior stream can be reported at a high frequency without an increase in the feedback bit number of CQI of each slot.

Here, as the feedback of CQI of the inferior stream, in addition to the method of reporting no CQI as shown in FIG. 13, there are the method of reporting the absolute value whose quantization step is coarse because of reduction in the bit number, the method of reporting the relative value (difference information) of CQI to the precedingly reported CQI of the inferior stream, the method of reporting the relative value (difference information) of CQI of the inferior stream to the absolute value of CQI of the superior stream, and others. In this case, an accuracy of CQI of the inferior stream is lowered, but the rough received quality of the inferior stream can be reported.

Also, instead of no report of CQI, other information may be reported as the feedback about the inferior stream. For example, it may be considered that the received quality information indicating to what extent the code word from which Nack is produced is mistaken, or the like is reported. As a result, an error level of the code word from which Nack is produced can be forecasted, and therefore the exact retransmission can be executed in the retransmitting operation.

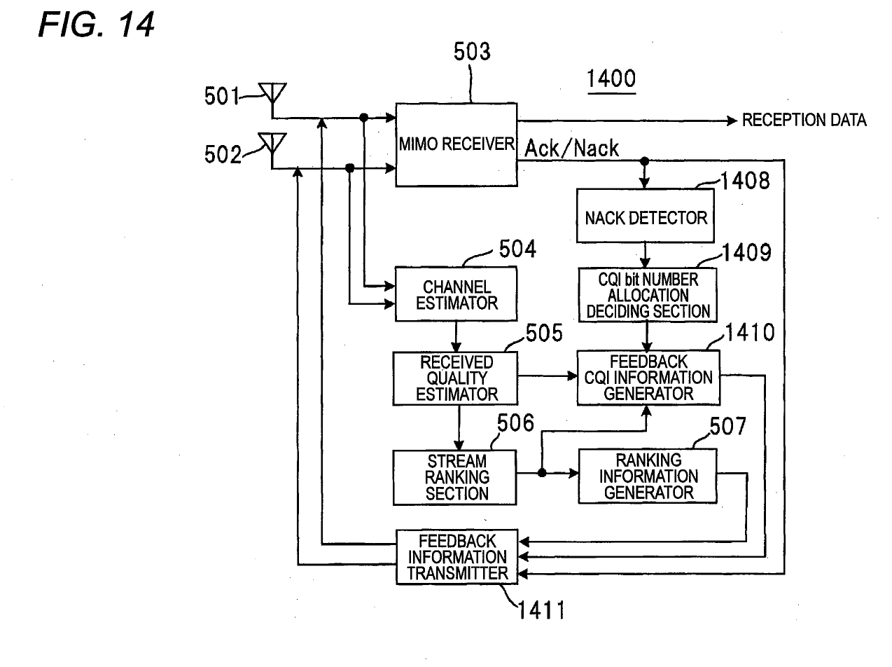

Next, a concrete configurative example of the radio communication apparatus according to the second embodiment is illustrated hereunder. FIG. 14 is a block diagram showing a configuration of a receiving apparatus of the second embodiment. A receiving apparatus 1400 includes the antennas 501, 502, the MIMO receiver 503, the channel estimator 504, the received quality estimator 505, the stream ranking section 506, the ranking information generator 507, a Nack detector 1408, a CQI bit number allocation deciding section 1409, a feedback CQI information generator 1410, and a feedback information transmitter 1411. Here, different constituent elements from those in the first embodiment will be explained hereunder, but the same reference symbols are affixed to the similar constituent elements to those in the first embodiment and their explanation will be omitted herein.

The Nack detector 1408 detects the generation of Nack to check whether or not Nack is present, based on the Ack/Nack signal that is produced/output by the MIMO receiver 503 as a response signal to each received code word. That is, the Nack detector 1408 detects whether or not the Nack signal is output, whether or not the error of the received data (reception failure) is caused, and the like, in response to the error decision result of the received data in the MIMO receiver 503. The CQI bit number allocation deciding section 1409 decides the allocation of the CQI bit number between the streams when the CQI is fed back as the received quality information indicating the received quality that is estimated by the received quality estimator 505, in response to the detected result in the Nack detector 1408. In the present embodiment, the allocation of CQI bit number is decided in such a manner that, when Nack is detected, the allocation of CQI bit number to the superior stream is increased and, when Nack is not detected, the allocation of CQI bit number to the superior stream is decreased and also the allocation of CQI bit number to the inferior stream is increased.

The feedback CQI information generator 1410 generates the feedback CQI information from the received quality of each stream estimated by the received quality estimator 505 in response to the CQI bit number that is decided by the CQI bit number allocation deciding section 1409 depending on the ranking level of each stream decided by the stream ranking section 506.

The feedback information transmitter 1411 executes the transmitting process that is applied to feed back the feedback information, which contains the Ack/Nack information, the above CQI information, and the ranking information, to the transmitting apparatus.

In the above configuration, the MIMO receiver 503 implements a function of the response signal generator. Also, the Nack detector 1408 and the CQI bit number allocation deciding section 1409 implement a function of the resource allocation controller. The feedback CQI information generator 1410 implements a function of the received quality information generator.

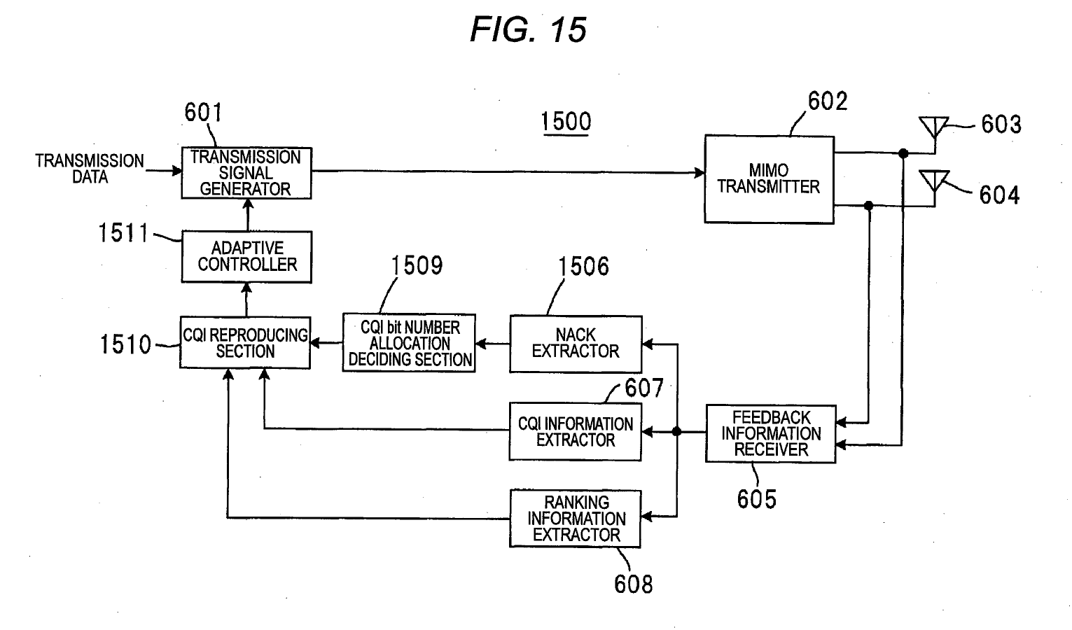

FIG. 15 is a block diagram showing a configuration of a transmitting apparatus of the second embodiment. A transmitting apparatus 1500 includes the transmission signal generator 601, the MIMO transmitter 602, the antennas 603, 604, the feedback information receiver 605, a Nack extractor 1506, the CQI information extractor 607, the ranking information extractor 608, a CQI bit number allocation deciding section 1509, a CQI reproducing section 1510, and an adaptive controller 1511. Here, different constituent elements from those in the first embodiment will be explained hereunder, but the same reference symbols are affixed to the similar constituent elements to those in the first embodiment and their explanation will be omitted herein.

The Nack extractor 1506 extracts the Nack information contained in the feedback information fed from the receiving apparatus. The CQI bit number allocation deciding section 1509 decides the allocation of the CQI bits between the streams as the resource allocation of the received quality information, in response to the extracted result in the Nack extractor 1506, like the CQI bit number allocation deciding section 1409. In the present embodiment, the CQI bit number allocation deciding section 1509 decides the allocation of the CQI bit number based on whether or not the Nack information is present and the ranking level of the streams. In this case, the allocation of CQI bit number is decided in such a manner that, when Nack is detected, the allocation of CQI bit number to the superior stream is increased and, when Nack is not detected, the allocation of CQI bit number to the superior stream is decreased and also the allocation of CQI bit number to the inferior stream is increased.

The CQI reproducing section 1510 reproduces the CQI indicating the received quality of each stream, by using the CQI information extracted by the CQI information extractor 607, the ranking information of respective streams extracted by the ranking information extractor 608, and the CQI bit allocation of respective streams decided by the CQI bit number allocation deciding section 1509. The adaptive controller 1511 controls the modulation system and the coding ratio of the transmission signal based on the reproduced CQI. Also, the adaptive controller 1511 applies the retransmission control at a time of retransmission when the transmitting apparatus receives the Nack signal from the receiving apparatus.

In the above configuration, the Nack extractor 1506 implements a function of the response signal extractor. Also, the CQI bit number allocation deciding section 1509 implements a function of the resource allocation deciding section. The CQI reproducing section 1510 implements a function of the received quality reproducing section.

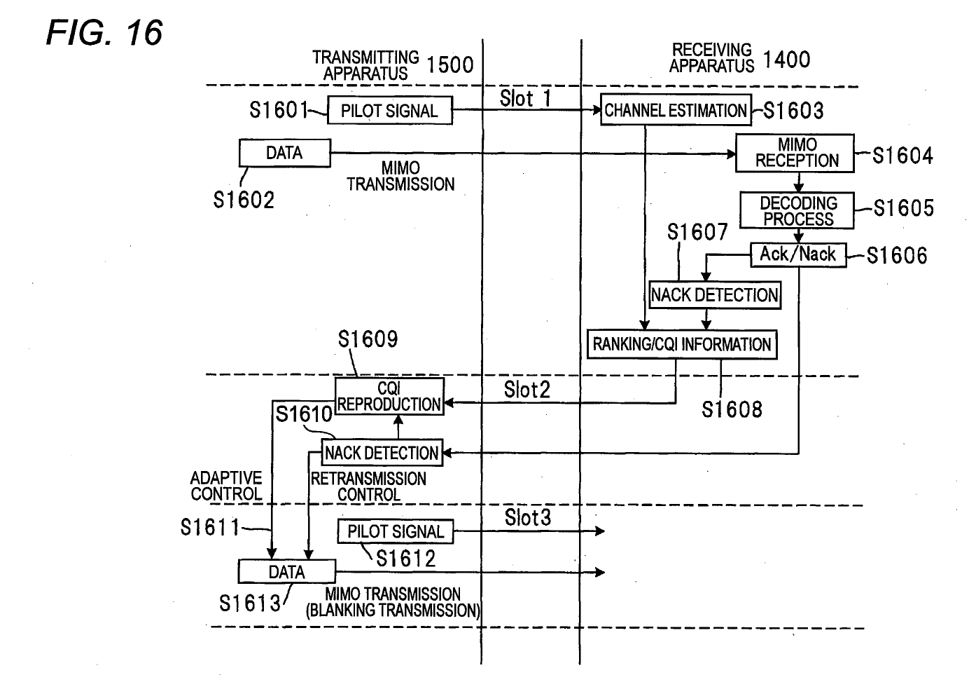

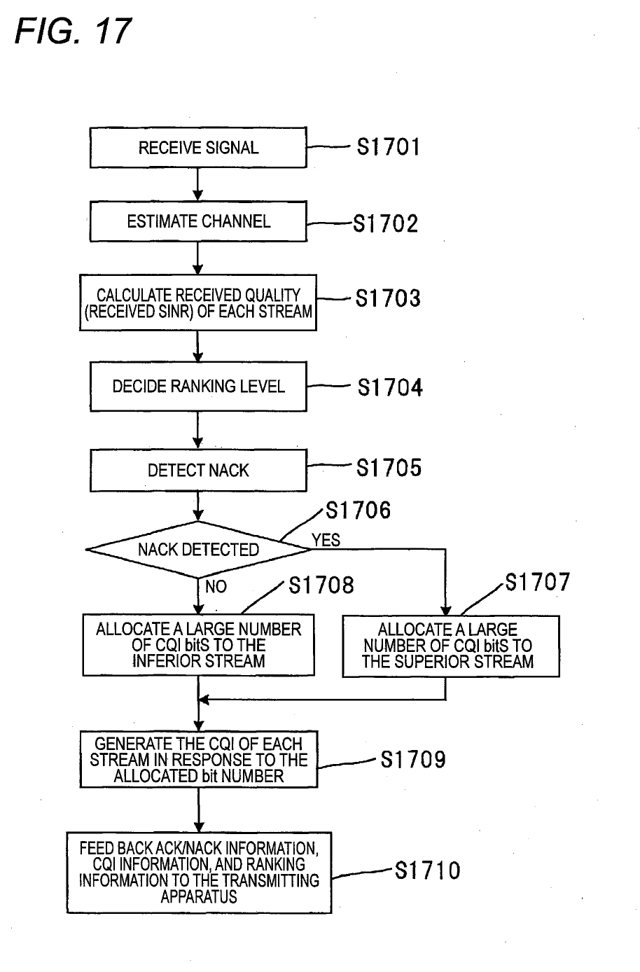

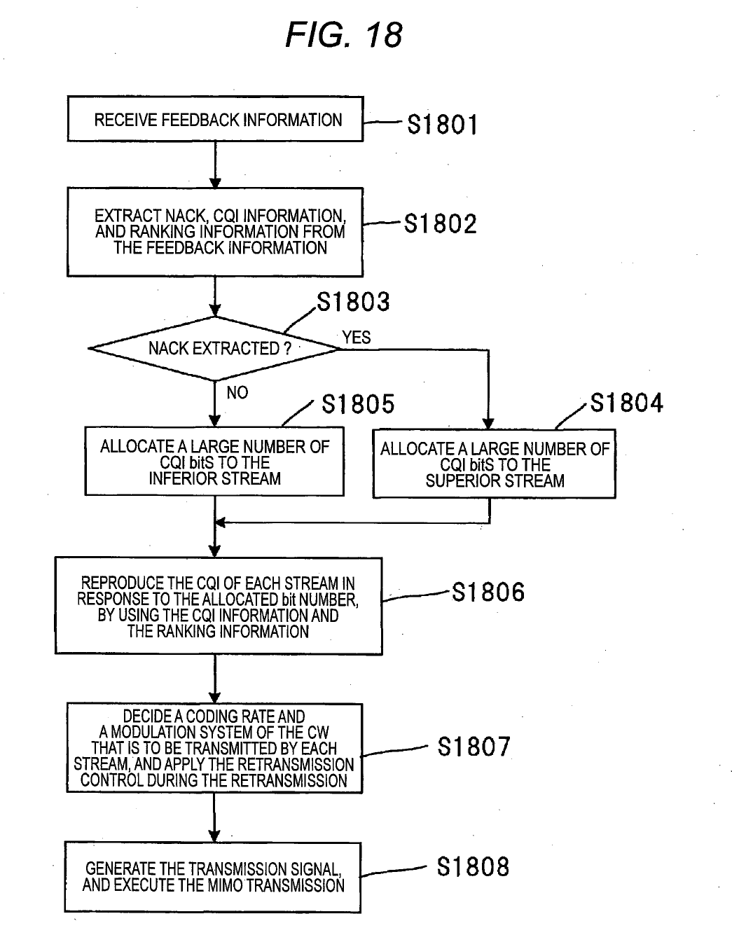

Next, a sequence and a flow of the process in the radio communication apparatus in the second embodiment will be explained hereunder. FIG. 16 shows a process sequence in the second embodiment, FIG. 17 shows a process flow in the receiving apparatus of the second embodiment, and FIG. 18 shows a process flow in the transmitting apparatus of the second embodiment.

A flow of a basic process will be explained by reference to the process sequence in FIG. 16 hereunder. Here, only the information associated with the present embodiment is illustrated. Successive slots (Slot 1, Slot 2, Slot 3) in the time slot are illustrated, but the slots are not limited to them.

First, in the slot 1 (Slot 1), the transmitting apparatus 1500 transmits the pilot signal and the data (S1601, S1602), and the receiving apparatus 1400 receives them. At this time, the data of multiple code words (MCW) are transmitted by multiple streams. The receiving apparatus 1400 executes the channel estimation by using the pilot signal (S1603). Also, the receiving apparatus 1400 MIMO-receives the reception data (S1604), applies the decoding process every code word (S1605), and generates the Ack/Nack information by making the error decision (S1606). Then, the receiving apparatus 1400 detects the Nack information (S1607), and then generates the ranking information and the CQI information of each stream by using the channel estimation value and the Ack/Nack information (S1608). At this time, the receiving apparatus 1400 generates the CQI information based on the Nack detected result.

In the slot 2 (Slot 2), the receiving apparatus 1400 feeds back the ranking information, the CQI information, and the Ack/Nack information, which are generated in the slot 1 in the receiver side, to the transmitting apparatus 1500. The transmitting apparatus 1500 reproduces the CQI of each code word, based on the Ack/Nack information, the ranking information, and the CQI information, which are fed back respectively (S1609). At this time, the transmitting apparatus 1500 detects the Nack information (S1610), and executes the reproduction of CQI and the retransmission control based on the Nack detected result.

In the slot 3 (Slot 3), the transmitting apparatus 1500 applies the adaptive control of MCS of the transmission data based on the CQI of each code word reproduced in the slot 2 (S1611). Then, the transmitting apparatus 1500 transmits the pilot signal and the data by repeating the processes in the slot 1 (S1612, S1613). In this case, when Nack is detected from the Ack/Nack information fed back in the slot 2, the transmitting apparatus 1500 makes the blanking transmission.

In turn, a process flow in the receiving apparatus will be explained in order by reference to FIG. 17 hereunder. In the receiving apparatus 1400, like the steps S801 to S804 shown in FIG. 8 in the first embodiment, the MIMO receiver 503 receives the signal transmitted from the transmitting apparatus 600 (S1701), the channel estimator 504 executes the channel estimation from the pilot signal (S1702), the received quality estimator 505 calculates the received quality of each stream by using the channel estimation value and makes the estimation (S1703), and the stream ranking section 506 decides the ranking level by ranking respective streams based on the received quality of each stream (S1704).

Then, the Nack detector 1408 detects Nack (S1705), and decides whether or not Nack is generated (S1706). At this time, the Nack detector 1408 decides whether or not the error is caused in multiple received code words, based on the error decided result of the receiving signal to which the receiving process is applied by the MIMO receiver 503.

The CQI bit number allocation deciding section 1409 decides the allocation of CQI bit number between the streams in response to whether or not Nack is generated. Here, when Nack is present in the decision in step S1706, the CQI bit number allocation deciding section 1409 decides such that a larger number of CQI bits should be allocated to the superior stream (S1707). In contrast, when Nack is not present in the decision in step S1706, the CQI bit number allocation deciding section 1409 decides such that a large number of CQI bits should be allocated to the inferior stream (S1708).

Then, the feedback CQI information generator 1410 generates the CQI information of each stream, in response to the received quality of each stream estimated in step S1703, the ranking level of each stream decided in step S1704, and the CQI bit number of each stream decided in steps S1707, S1708 (S1709). Then, the feedback information transmitter 1411 feeds back the Ack/Nack information, the CQI information, and the ranking information to the transmitting apparatus 1500 (S1710).

Next, a process flow in the transmitting apparatus will be explained in order by reference to FIG. 18 hereunder. In the transmitting apparatus 1500, the feedback information receiver 605 receives the feedback information from the receiving apparatus 1400 (S1801). Then, the Nack extractor 1506 extracts the Nack information from the feedback information received in step S1801, the CQI information extractor 607 extracts the CQI information from the same information, and the ranking information extractor 608 extracts the ranking information from the same information (S1802).

Then, the CQI bit number allocation deciding section 1509 decides whether or not Nack is present in the Nack information extracted in step S1802 (S1803), and then decides the allocation of CQI bit number between the streams in response to whether or not Nack is extracted. Here, when Nack is extracted, the CQI bit number allocation deciding section 1509 decides such that a larger number of CQI bits should be allocated to the superior stream (S1804). In contrast, when Nack is not extracted, the CQI bit number allocation deciding section 1509 decides such that a larger number of CQI bits should be allocated to the inferior stream (S1805). Then, the CQI reproducing section 1510 reproduces the CQI of each stream by using the CQI information and the ranking information extracted in step S1802, in response to the allocation of CQI bit number decided in steps S1804, S1805 (S1806).

Then, the adaptive controller 1511 decides the coding rate and the modulation system of the code word that is to be transmitted by each stream, based on CQI of each stream reproduced in step S1806. Also, the adaptive controller 1511 applies the retransmission control during the retransmission (S1807). Then, the transmission signal generator 601 and the MIMO transmitter 602 generate the transmission signal based on the coding rate and the modulation system of the code word decided in step S1807, and execute the MIMO transmission (S1808).

In this manner, according to the second embodiment, the configuration for changing the allocation of the CQI bit number in response to whether or not Nack is generated is provided, and a larger number of CQI bits should be allocated to the superior stream when Nack is generated whereas a larger number of CQI bits should be allocated to the inferior stream when Nack is not generated. Accordingly, occurrence of the error of CQI can be suppressed while reducing an amount of information of the CQI feedback. As a result, even though the number of code words is increased in the data transmission of MCW using multiple streams, an amount of information required for the feedback every code word can be reduced, and also occurrence of the error in the feedback CQI due to a big variation in a propagation path condition can be suppressed, so that the performance degradation can be prevented. Also, the essentially required CQI can be reported at a high frequency to compensate for occurrence of the CQI error due to the compression of information in the CQI feedback, and therefore such an advantage can be achieved that the performance degradation is prevented. Also, a reduction in the frequency utilization efficiency in the reverse link that is used to inform the feedback information can be prevented.

(Variation 1)

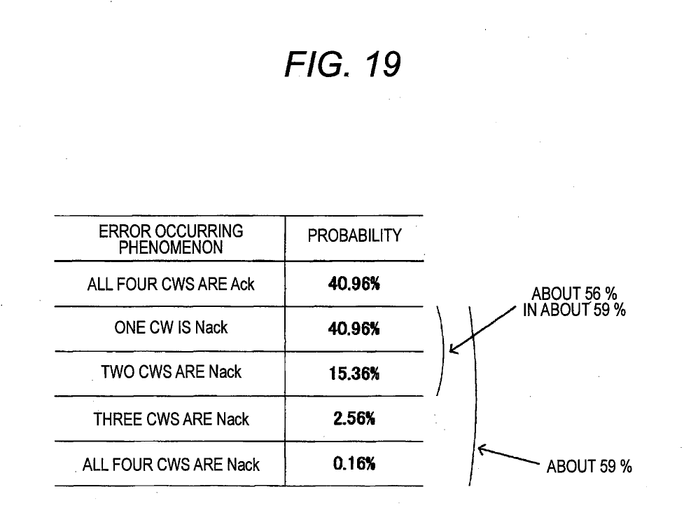

As a variation (variation 1) of the second embodiment, an example of the four stream transmission is illustrated hereunder. FIG. 19 shows an error occurring probability when four code words are transmitted in four streams. Like the case of two code words shown in FIG. 12, when a target PER is set to 20%, an error occurring probability in transmitting four streams (four code words) is given by about 59% that is derived by adding respective probabilities that one code word or more are decided as Nack. Also, when the error is caused, a probability that the error occurs simultaneously in three or all code words out of four code words is low, but a probability that the error occurs in one or two code words is dominant like about 56% in about 59%. From this fact, it may be considered that the two stream transmission is optimal at a maximum in the blanking in the four stream (four code words) transmission. Accordingly, the feedback CQI can be handled independently in the two superior streams and the two inferior streams.

As described above, it is desired that, in the four stream (four code words) transmission, two code words should be ensured at a maximum as the number of code words of which the retransmission is required when the error occurs simultaneously. Therefore, in this Variation 1, such a situation is applied to the case of the four stream transmission that the maximum number of code words transmitted in the blanking is set to 2, and two superior streams are used as the superior stream and two inferior streams are used as the inferior stream.

That is, in Variation 1, the bit allocation of CQI between two superior streams and two inferior streams is changed in the CQI feedback being informed before the blanking transmission is made in answer to occurrence of Nack, and the absolute value (5 bits) of CQI of two superior streams is reported. Accordingly, the absolute value of CQI of two superior streams can be reported without an increase in the feedback bit number.

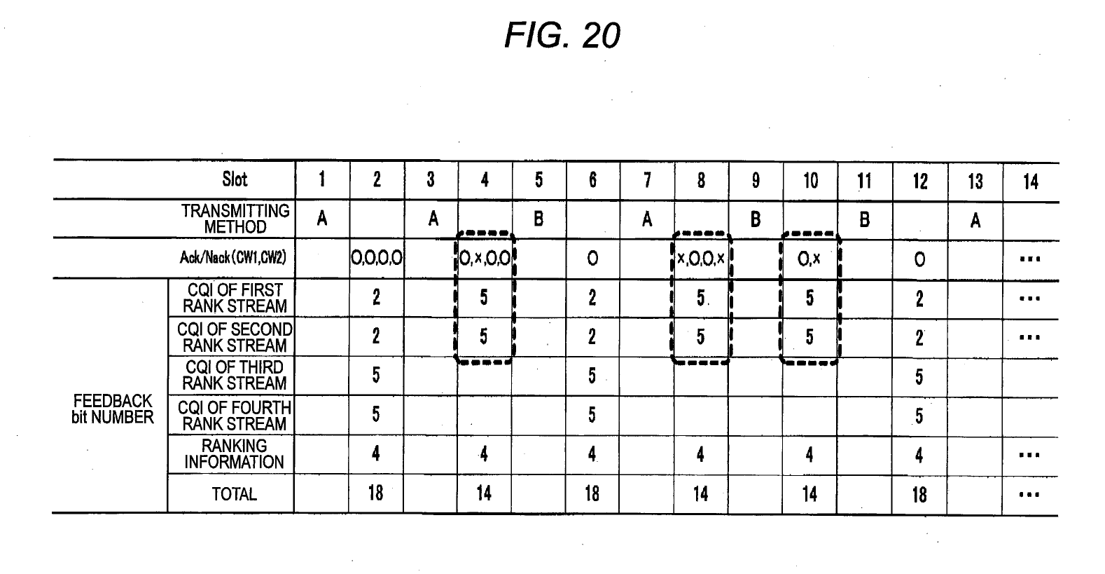

Next, a concrete method of allocating the CQI bit number in the variation of the second embodiment is illustrated hereunder. FIG. 20 shows an example of the feedback bit number of CQI in transmitting four streams in the variation of the second embodiment. In FIG. 20, contents of respective items are similar to those shown in FIG. 13.

In an example in FIG. 20, the slots 4, 8, 10 correspond to the slot that feeds back Nack when the error is caused in the transmitted CW. In the slots 5, 9, 11 next to these slots, the blanking transmission is executed by the transmitting method B, or the like in FIG. 11, and only the CW in which Nack is generated is retransmitted from two superior streams. Since the CW is transmitted only by two superior streams in this blanking transmission, CQI of two inferior streams is not needed. Therefore, in the CQI feedback in the slots (slots 4, 8, 10) before the blanking transmission is made, only the absolute value of CQI of two superior streams is reported. As a result, the absolute value of CQI of the superior stream can be reported at a high frequency without an increase in the feedback bit number of CQI of each slot.

Because only two superior streams are required in this case, merely four bits that can notify 12 combinations in total are needed as the ranking information. Also, only when two superior streams and two inferior streams should be decided, merely three bits that can inform 6 combinations in total are needed as the ranking information.

Here, except that the number of antennas in the transmitting apparatus and the receiving apparatus and also two superior streams and two inferior streams correspond to the superior stream and the inferior stream in the process flow respectively, the apparatus configuration and the processing operation are similar to those in the block diagram and the process flow in the second embodiment.

In this manner, the similar advantages to those in the second embodiment can be achieved in the four stream (four code words) transmission in Variation 1.

### Third Embodiment

A third embodiment illustrates an example in which a part of the above second embodiment is varied. A difference from the second embodiment resides in that, only when Nack is generated in the code word that is transmitted in the superior stream, the allocation of CQI bit number between the streams is varied.

In case an error occurs in the superior stream, there is a possibility that the CQI error occurring phenomenon shown in FIG. 10 occurs in the superior stream. However, the phenomenon shown in FIG. 10 does not occur in the inferior stream because the absolute value of CQI is fed back. That is, when no error occurs in the superior stream but an error occurs only in the inferior stream, it is possible to say that reliability of the CQI information of the superior stream is high. In this case, it may be considered that the absolute value should not be transmitted on purpose as the CQI information of the superior stream. In this manner, when an error occurs only in the inferior stream, the relative value of CQI of the superior stream is informed without change of the allocation of the CQI bit. As a result, the number of bits in the CQI feedback can be reduced further more.

As described above, in the third embodiment, in the CQI feedback that is done before the blanking transmission is made because Nack is generated in the superior stream, the bit allocation of CQI between the streams is changed and the absolute value (5 bits) of CQI of the superior stream is reported. In contrast, in the CQI feedback that is done before the blanking transmission is made because Nack is generated only in the inferior stream, the relative value (2 bits) of CQI of the superior stream is reported but the inferior stream is not reported. As a result, the absolute value of CQI of the superior stream can be reported without an increase in the feedback bit number.

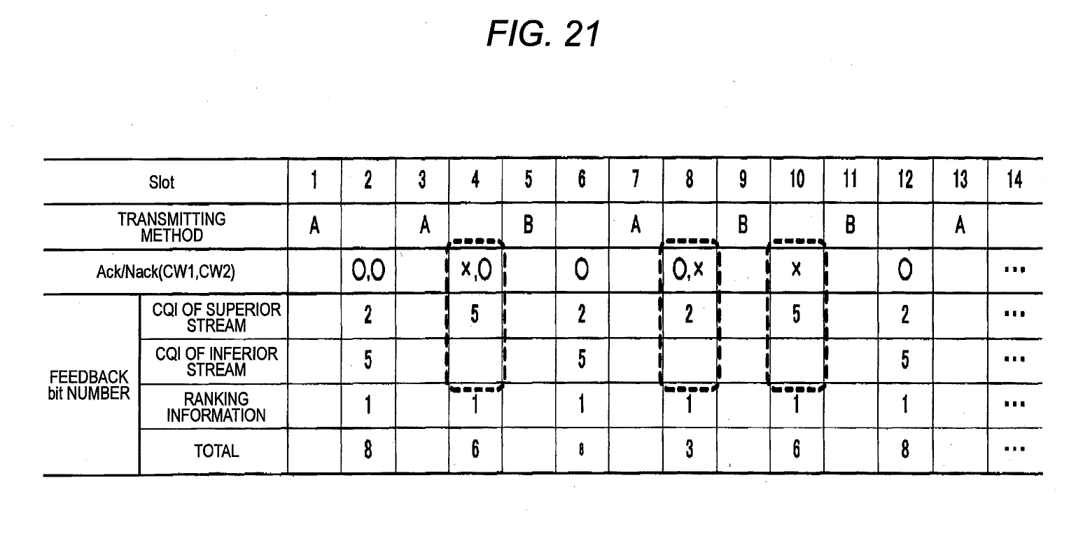

Next, a concrete method of allocating the CQI bit number in the third embodiment is illustrated hereunder. FIG. 21 shows an example of the feedback bit number of CQI in the third embodiment of the present invention. In FIG. 21, contents of respective items are similar to those shown in FIG. 13.

In an example in FIG. 21, the slots 4, 8, 10 correspond to the slot that feeds back Nack when the error is caused in the transmitted CW. Nacks fed back in the slots 4 and 10 are issued to the CW transmitted in the superior stream. In contrast, Nack fed back in the slot 8 is issued to the CW transmitted in the inferior stream.

When the error is caused in the superior stream such as the slot 4 or 10, it is possible that the error is caused by the CQI error. Therefore, the absolute value of CQI is reported to improve reliability of CQI in the superior stream. Then, in the slots 5, 11 as the next slots, the blanking transmission is made by the transmitting method B, or the like in FIG. 11 and only the CW in which Nack is generated is retransmitted from the superior stream. Also, when the error is caused in the inferior stream such as the slot 8 but no error is caused in the superior stream, reliability of CQI of the superior stream is high. Therefore, the relative value (difference information) of CQI of the superior stream is reported. Also, in the slot 9 as the next slot, the blanking transmission is made similarly, and only the CW in which Nack is generated is retransmitted from the superior stream. As a result, the absolute value of CQI of the superior stream can be reported at a high frequency without an increase in the feedback bit number of CQI of each slot.

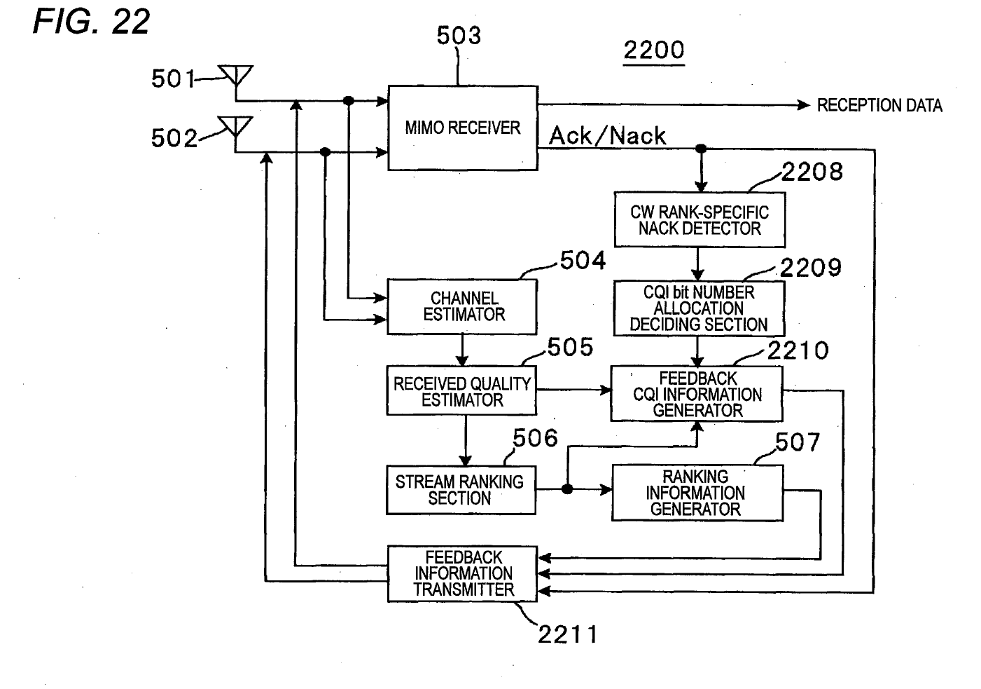

Next, a concrete configurative example of a radio communication apparatus according to the third embodiment is shown. FIG. 22 is a block diagram showing a configuration of a receiving apparatus of the third embodiment. A receiving apparatus 2200 is constructed to include the antennas 501, 502, the MIMO receiver 503, the channel estimator 504, the received quality estimator 505, the stream ranking section 506, the ranking information generator 507, a CW rank-specific Nack detector 2208, a CQI bit number allocation deciding section 2209, a feedback CQI information generator 2210, and a feedback information transmitter 2211. Here, different constituent elements from those in the first and second embodiments will be explained hereunder, but the same reference symbols are affixed to the similar constituent elements to those in the first and second embodiments and their explanation will be omitted herein.

In the receiving apparatus 2200 of the third embodiment, a different portion from the second embodiment shown in FIG. 14 is that the CW rank-specific Nack detector 2208 is provided instead of the Nack detector 1408. The CW rank-specific Nack detector 2208 detects whether or not Nack is present by the ranking of the CWs, based on the Ack/Nack information of the received code words.

The CQI bit number allocation deciding section 2209 decides the allocation of the CQI bit number between the streams in response to the detected result in the CW rank-specific Nack detector 2208. In the present embodiment, when Nack is generated in the code word being transmitted in the superior stream, the allocation of the CQI bit number of the superior stream is increased. Also, when Ack is issued to the code word being transmitted in the superior stream but Nack is generated in the code word being transmitted in the inferior stream, the allocation of the CQI bit number of the superior stream is decreased. Also, when Nack is not detected, the allocation of the CQI bit number of the superior stream is decreased and the allocation of the CQI bit number of the inferior stream is increased.

The feedback CQI information generator 2210 generates the feedback CQI information from the received quality of each stream estimated by the received quality estimator 505, in response to the CQI bit number decided by the CQI bit number allocation deciding section 2209, according to the ranking level of each stream decided by the stream ranking section 506. The feedback information transmitter 2211 executes the transmitting process to feed back the feedback information including the Ack/Nack information, the above CQI information, and the ranking information to the transmitting apparatus.

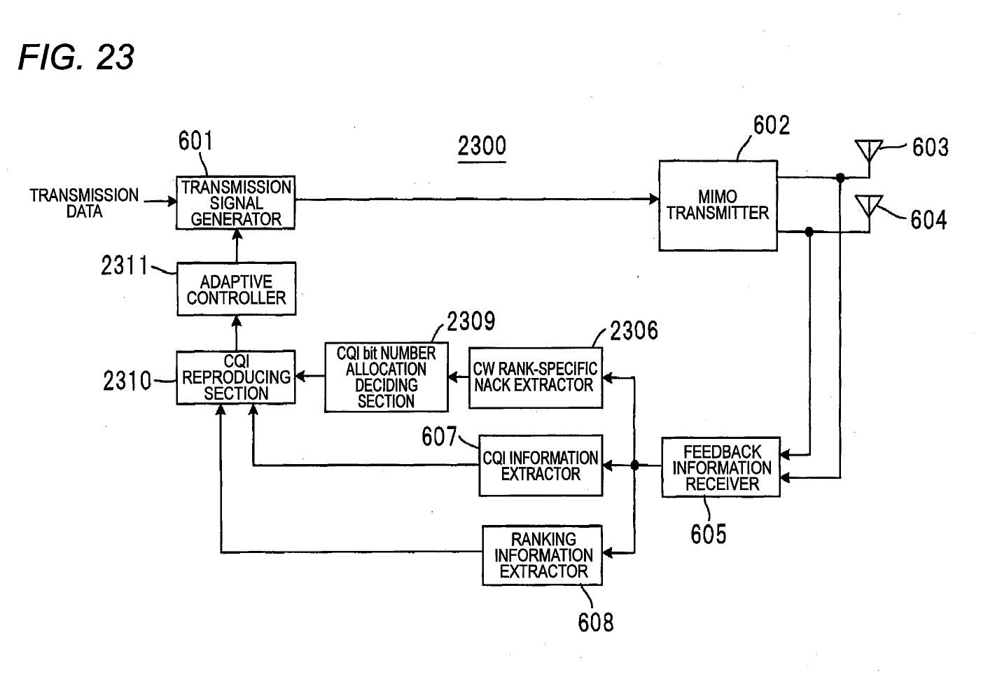

FIG. 23 is a block diagram showing a configuration of the transmitting apparatus of the third embodiment. Here, a transmitting apparatus 2300 is constructed to include the transmission signal generator 601, the MIMO transmitter 602, the antennas 603, 604, the feedback information receiver 605, a CW rank-specific Nack extractor 2306, the CQI information extractor 607, the ranking information extractor 608, a CQI bit number allocation deciding section 2309, a CQI reproducing section 2310, and an adaptive controller 2311. Here, different constituent elements from those in the first and second embodiments will be explained hereunder, but the same reference symbols are affixed to the similar constituent elements to those in the first and second embodiments and their explanation will be omitted herein.

In the transmitting apparatus 2300 of the third embodiment, a different portion from the second embodiment shown in FIG. 15 is that the CW rank-specific Nack extractor 2306 is provided instead of the Nack extractor 1506. The CW rank-specific Nack extractor 2306 detects whether or not Nack is present according to the ranking of the CWs, based on the Ack/Nack information contained in the feedback information fed from the receiving apparatus, and extracts Nack when Nack is present.

The CQI bit number allocation deciding section 2309 decides the allocation of the CQI bit number between the streams in response to the extracted result in the CW rank-specific Nack extractor 2306, like the CQI bit number allocation deciding section 2209 in the receiving apparatus 2200. In the present embodiment, the CQI bit number allocation deciding section 2309 decides the allocation of the CQI bit number based on the presence/absence of the Nack information according to the CW rank and the ranking level of the stream. Here, when Nack is extracted from the code word being transmitted in the superior stream, the allocation of the CQI bit number of the superior stream is increased. Also, when Ack is issued to the code word being transmitted in the superior stream but Nack is extracted from the code word being transmitted in the inferior stream, the allocation of the CQI bit number of the superior stream is decreased. Also, when Nack is not detected, the allocation of the CQI bit number of the superior stream is decreased and the allocation of the CQI bit number of the inferior stream is increased.

The CQI reproducing section 2310 reproduces the CQI indicating the received quality of each stream, by using the CQI information extracted by the CQI information extractor 607, the ranking information of respective streams extracted by the ranking information extractor 608, and the CQI bit allocation of respective streams decided by the CQI bit number allocation deciding section 2309. The adaptive controller 2311 controls the modulation system and the coding ratio of the transmission signal based on the reproduced CQI. Also, the adaptive controller 2311 applies the retransmission control at a time of retransmission when the transmitting apparatus receives the Nack signal from the receiving apparatus.

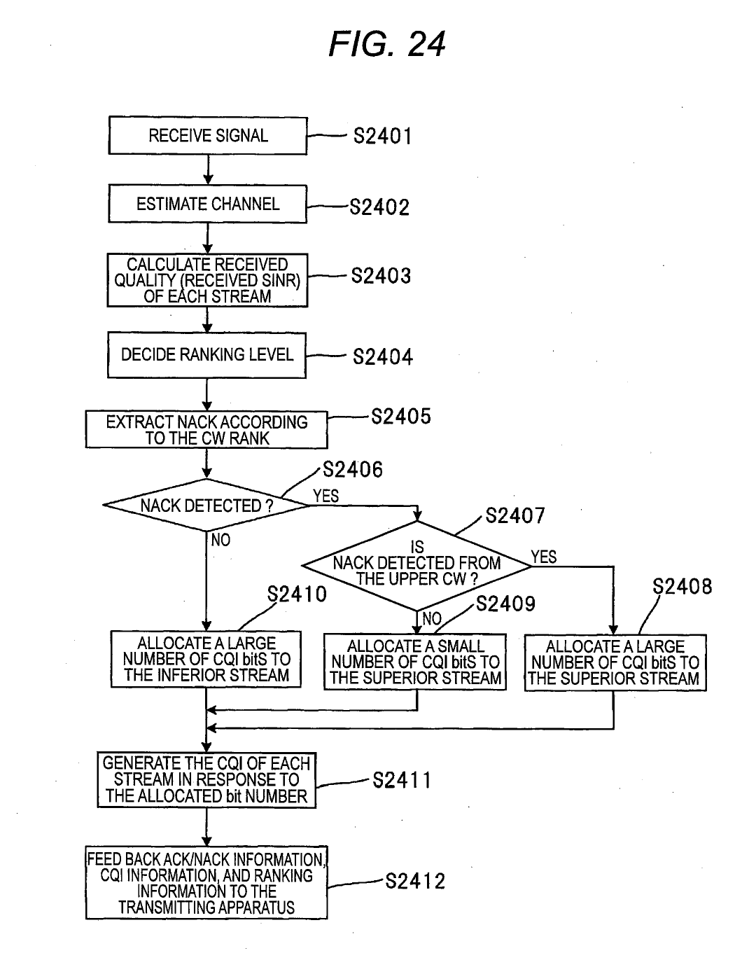

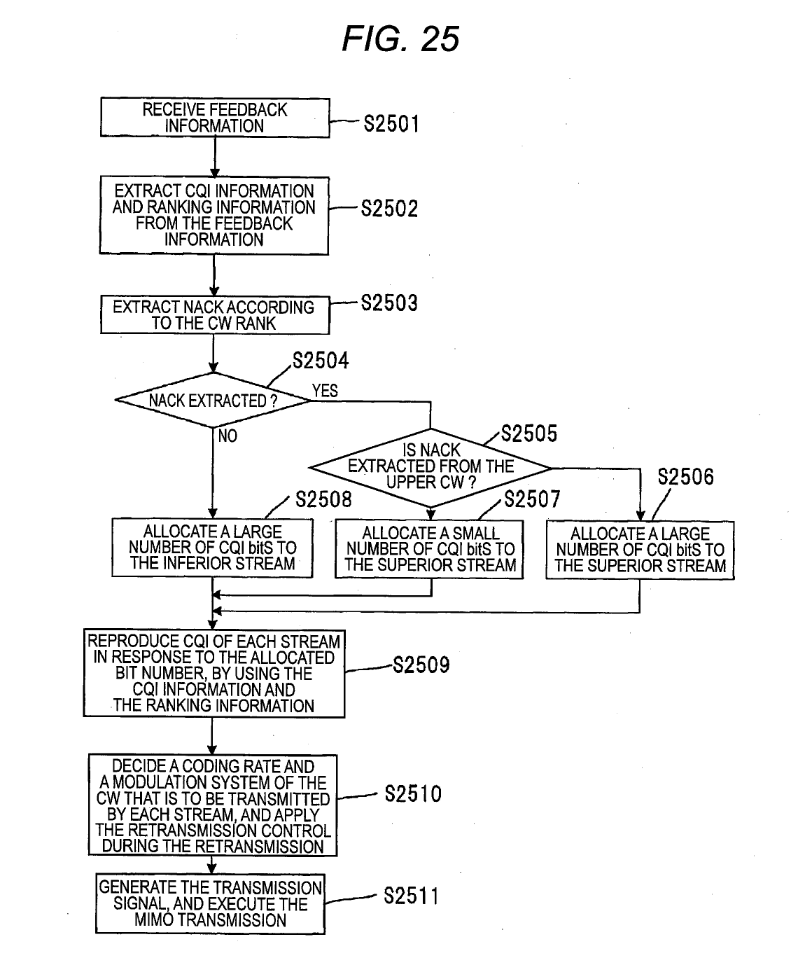

Next, a process flow in the radio communication apparatus of the third embodiment will be explained hereunder. FIG. 24 shows a process flow in the receiving apparatus of the third embodiment, and FIG. 25 shows a process flow in the transmitting apparatus of the third embodiment.

In the process flow in the receiving apparatus shown in FIG. 24, a different portion from the second embodiment resides in the processes executed in the CW rank-specific Nack detector 2208 and the CQI bit number allocation deciding section 2209. In the receiving apparatus 2200, like the steps S1701 to S1704 in the second embodiment shown in FIG. 17, the MIMO receiver 503 receives the signal from the transmitting apparatus 2300 (S2401), the channel estimator 504 executes the channel estimation from the pilot signal (S2402), the received quality estimator 505 calculates and estimates the received quality of each stream by using the channel estimation value (S2403), and the stream ranking section 506 decides the ranking level by ranking respective streams by using the received quality of each stream (S2404).

Then, the CW rank-specific Nack detector 2208 extracts Nack according to the CW rank (S2405), and decides whether or not Nack is caused every ranking level of the stream in which each code word is transmitted (S2406). At this time, the CW rank-specific Nack detector 2208 decides in which one of the upper code word and the lower code word the error is caused among multiple received code words, based on the error decision result of the reception signal that underwent the receiving process by the MIMO receiver 503.

Then, the CQI bit number allocation deciding section 2209 decides the allocation of the CQI bit number between the streams in response to whether or not Nack is caused according to the CW rank. Here, when Nack is extracted in the decision in step S2406, the CQI bit number allocation deciding section 2209 decides whether or not Nack is detected from the upper code word (S2407). When Nack is extracted from the code word being transmitted in the superior stream, the CQI bit number allocation deciding section 2209 decides to allocate a larger number of CQI bits to the superior stream (S2408). Also, when Ack is issued to the code word being transmitted in the superior stream but Nack is extracted from the code word being transmitted in the inferior stream, the CQI bit number allocation deciding section 2209 decides to allocate a small number of CQI bits to the superior stream (S2409). In contrast, when Nack is not extracted in the decision in step S2406, the CQI bit number allocation deciding section 2209 decides to allocate a larger number of CQI bits to the inferior stream (S2410).

Then, the feedback CQI information generator 2210 generates the CQI information of each stream, in response to the received quality of each stream estimated in step S2403, the ranking level of each stream decided in step S2404, and the CQI bit number of each stream decided in steps S2408, S2409, S2410 (S2411). Then, the feedback information transmitter 2211 feeds back the Ack/Nack information, the CQI information, and the ranking information to the transmitting apparatus 2300 (S1710).

Also, in the process flow in the receiving apparatus shown in FIG. 25, a different portion from the second embodiment resides in the processes in the CW rank-specific Nack extractor 2306 and the CQI bit number allocation deciding section 2309. In the transmitting apparatus 2300, the feedback information receiver 605 receives the feedback information from the receiving apparatus 2200 (S2501). Then, the CQI information extractor 607 extracts the CQI information from the feedback information received in step S2501, and the ranking information extractor 608 extracts the ranking information from the feedback information (S2502).

Also, the CW rank-specific Nack extractor 2306 extracts the Nack information according to the CW level from the feedback information received in step S2501. At this time, the CW rank-specific Nack extractor 2306 decides from which one of the upper code word and the lower code word the Nack is extracted every ranking level of the stream through which each code word is transmitted.

Then, the CQI bit number allocation deciding section 2309 extracts the Nack information according to the CW rank (S2503), decides whether or not Nack is extracted from the Nack information (S2504), and decides the allocation of the CQI bit number between the streams in response to whether or not Nack is extracted. Here, when Nack is extracted, the CQI bit number allocation deciding section 2309 decides whether or not Nack is extracted from the upper code word (S2505). When Nack is extracted from the code word being transmitted in the superior stream, the CQI bit number allocation deciding section 2309 decides to allocate a larger number of CQI bits to the superior stream (S2506). Also, when Ack is issued to the code word being transmitted in the superior stream but Nack is extracted from the code word being transmitted in the inferior stream, the CQI bit number allocation deciding section 2309 decides to allocate a small number of CQI bits to the superior stream (S2507). In contrast, when Nack is not extracted, the CQI bit number allocation deciding section 2309 decides to allocate a large number of CQI bits to the inferior stream (S2508).

Then, the CQI reproducing section 2310 reproduces the CQI of each stream in response to the allocation of the CQI bit number decided in step S2506, step S2507, step S2508, by using the CQI information and the ranking information extracted in step S2502 (S2509). Then, the adaptive controller 2311 decides the coding rate and the modulation system of the code word that is to be transmitted by each stream, based on CQI of each stream reproduced in step S2509. Also, the adaptive controller 2311 applies the retransmission control during the retransmission (S2510). Then, the transmission signal generator 601 and the MIMO transmitter 602 generate the transmission signal based on the coding rate and the modulation system of the code word decided in step S2510, and execute the MIMO transmission (S2511).

In this manner, according to the third embodiment, the allocation of the CQI bit number is changed in response to whether or not Nack is caused according to the CW rank. When Nack is extracted from the code word being transmitted in the superior stream, a larger number of CQI bits to the superior stream is allocated. Also, when Ack is issued to the code word being transmitted in the superior stream but Nack is extracted from the code word being transmitted in the inferior stream, a small number of CQI bits to the superior stream is allocated. In contrast, when Nack is not extracted, a larger number of CQI bits to the inferior stream is allocated. Accordingly, in addition to the advantage of the second embodiment, an amount of information of the CQI feedback can be reduced further more.

(Variation 2)

As a variation (Variation 2) of the third embodiment, an example of other feedback information when an error is caused only in the inferior stream is illustrated.

In the above third embodiment, when Ack is issued to the code transmitted in the superior stream but Nack is caused from the code word transmitted in the inferior stream, the CQI of the superior stream is fed back by a small bit, and no CQI of the inferior stream is fed back. In this case, since the CQI of the superior stream is fed back by a small bit, the bit number in the feedback information can be reduced considerably. Therefore, in this Variation 2, the information indicating an error situation concerning the error that is caused in the inferior stream, e.g., a channel condition in the inferior stream, or the like is added in reporting by using the reduced feedback bit.

As the case in Variation 2, if the error situation such as the channel condition of the code word from which Nack is issued, or the like is known, it can be detected to what extent the retransmission data is required in the retransmission operation to correct the error. As a result, a throughput can be improved by adding the data newly, while preventing an event that the retransmission data is transmitted excessively.

### Fourth Embodiment

A fourth embodiment shows an example in which a part of the above second embodiment is changed. A difference from the second embodiment resides in that, when the ranking level of the stream is changed, the allocation of the CQI bit number between the streams is changed.

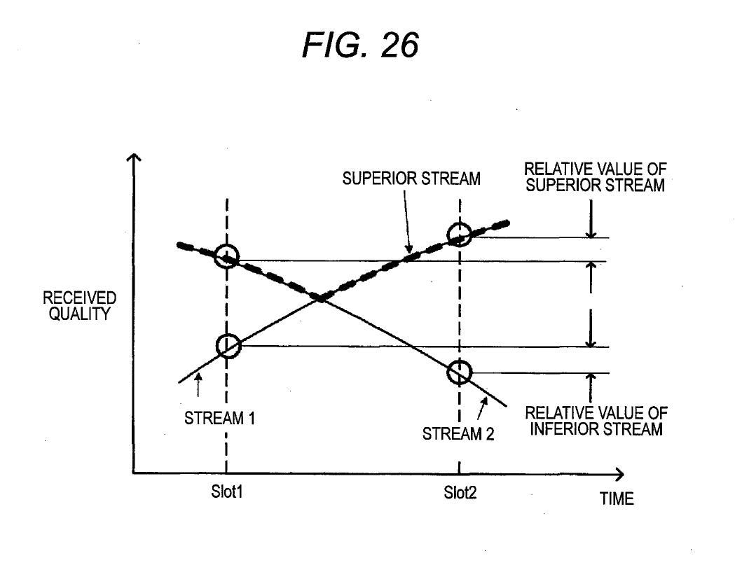

When the ranking level of the stream is changed in transmitting multiple streams, a difference in quality between the streams becomes small, and an amount of change in quality per time is suppressed to the substantially same extent in respective streams. FIG. 26 shows a behavior when the ranking level of the stream is changed. In FIG. 26, the superior stream is indicated with a thick line. In the slot 1 (Slot 1), the superior stream is the stream 2 and the inferior stream is the stream 1. Then, in the slot 2 (Slot 2), the superior stream is the stream 1 and the inferior stream is the stream 2. In this manner, in some cases the ranking level of the stream is changed between the slots.

In this case, the received quality becomes close between the superior stream and the inferior stream, an amount of change in received quality in time is suppressed to the substantially same extent in respective streams, and a variation of the received quality becomes small in both the superior stream and the inferior stream. Therefore, it is possible to say that the relative value whose dynamic range is narrow is enough to represent the CQI. As a result, the feedback bit number for the CQI in the inferior stream can be reduced further more.

Accordingly, in the fourth embodiment, when the ranking level of the stream is changed, the equal number of bits is allocated to the superior stream and the inferior stream based on the above respect, and the CQI of the relative value (difference information) is fed back in respective streams.

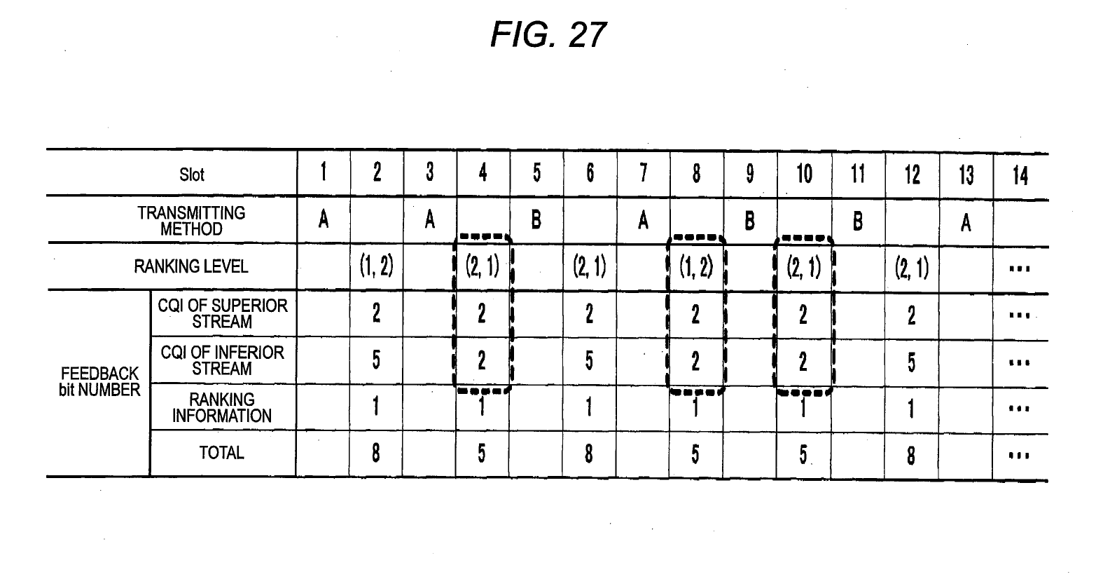

Next, a concrete method of allocating the CQI bit number in the fourth embodiment will be illustrated hereunder. FIG. 27 shows an example of the feedback bit number of CQI in the fourth embodiment of the present invention. In FIG. 27, a difference in contents of respective items from those in FIG. 13 is that the ranking level is shown instead of Ack/Nack. Remaining contents are similar to those shown in FIG. 13.

In an example in FIG. 27, the slots 4, 8, 10 correspond to the slot in which the ranking level is changed from the preceding ranking level. Since the situation shown in FIG. 26 occurs in respective streams in these slots, both the superior stream and the inferior stream report the relative value (2 bits) of CQI. Accordingly, the feedback bit number can be reduced in the slots 4, 8, 10. In this case, in the slot in which the ranking level is not changed, the superior stream reports the relative value (2 bits) of CQI, and the inferior stream reports the absolute value (5 bits) of CQI.

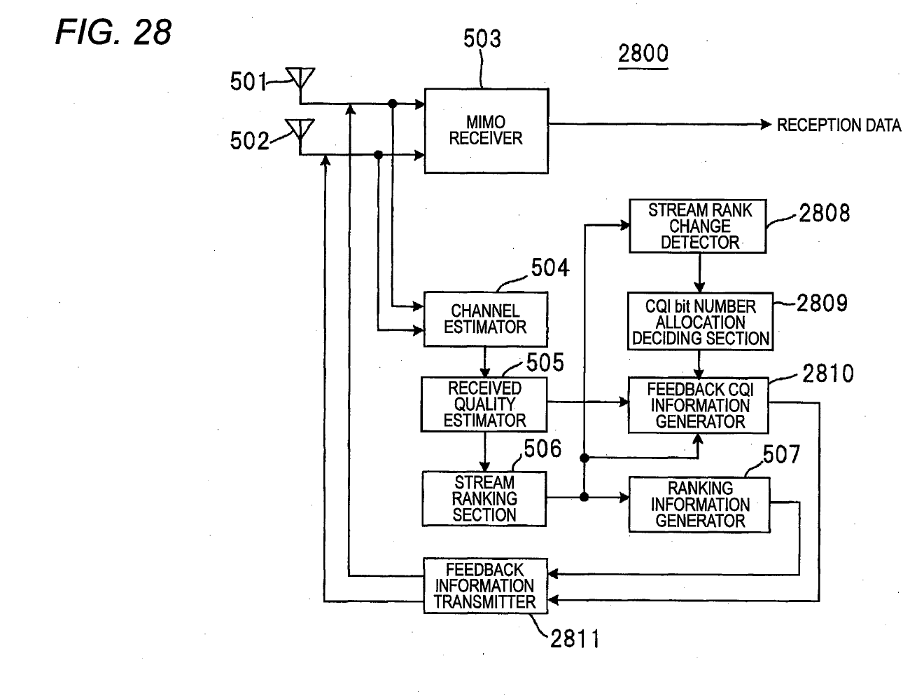

Next, a concrete configurative example of the radio communication apparatus according to the fourth embodiment is shown hereunder. FIG. 28 is a block diagram showing a configuration of the receiving apparatus of the fourth embodiment. A receiving apparatus 2800 is constructed to include the antennas 501, 502, the MIMO receiver 503, the channel estimator 504, the received quality estimator 505, the stream ranking section 506, the ranking information generator 507, a stream rank change detector 2808, a CQI bit number allocation deciding section 2809, a feedback CQI information generator 2810, and a feedback information transmitter 2811. Here, different constituent elements from those in the first and second embodiments will be explained hereunder, but the same reference symbols are affixed to the similar constituent elements to those in the first and second embodiments and their explanation will be omitted herein.

In the receiving apparatus 2800 of the fourth embodiment, a different portion from the second embodiment shown in FIG. 14 is that the stream rank change detector 2808 is provided instead of the Nack detector 1408. The stream rank change detector 2808 detects whether or not the ranking level of the stream is changed from the preceding report (the preceding slot) based on the ranking level of each stream decided in the stream ranking section 506.

The CQI bit number allocation deciding section 2809 decides the allocation of the CQI bit number between the streams in response to the detected result in the stream rank change detector 2808. In the present embodiment, when a change occurs in the stream rank, a smaller bit number is allocated equally to the CQls of the superior stream and the inferior stream. Also, when no change occurs in the stream rank, the bit number is allocated such that the CQI bit number of the superior stream is decreased and the CQI bit number of the inferior stream is increased.

The feedback CQI information generator 2810 generates the feedback CQI information from the received quality of each stream estimated by the received quality estimator 505, in response to the CQI bit number decided by the CQI bit number allocation deciding section 2809, according to the ranking level of each stream decided by the stream ranking section 506. The feedback information transmitter 2811 executes the transmitting process to feed back the feedback information including the Ack/Nack information, the above CQI information, and the ranking information to the transmitting apparatus.

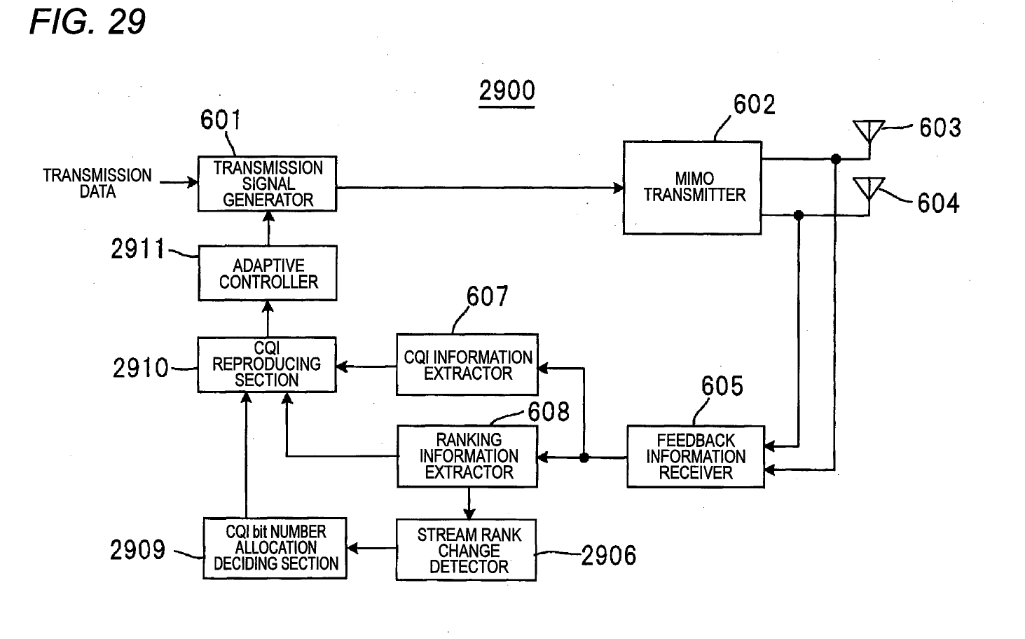

FIG. 29 is a block diagram showing a configuration of the transmitting apparatus of the fourth embodiment. A transmitting apparatus 2900 is constructed to include the transmission signal generator 601, the MIMO transmitter 602, the antennas 603, 604, the feedback information receiver 605, the CQI information extractor 607, the ranking information extractor 608, a stream rank change detector 2906, a CQI bit number allocation deciding section 2909, a CQI reproducing section 2910, and an adaptive controller 2911. Here, different constituent elements from those in the first and second embodiments will be explained hereunder, but the same reference symbols are affixed to the similar constituent elements to those in the first and second embodiments and their explanation will be omitted herein.

In the transmitting apparatus 2900 of the fourth embodiment, a different portion from the second embodiment shown in FIG. 15 is that the stream rank change detector 2906 is provided instead of the Nack extractor 1506. The stream rank change detector 2906 detects whether or not the ranking level of the stream is changed from the preceding report (the preceding slot) by using the ranking information extracted by the ranking information extractor 608.

The CQI bit number allocation deciding section 2909 decides the allocation of the CQI bit number between the streams in response to the detected result in the stream rank change detector 2906, like the CQI bit number allocation deciding section 2809 in the receiving apparatus 2800. In the present embodiment, the CQI bit number allocation deciding section 2909 decides the allocation of the CQI bit number based on whether or not the ranking level of the stream is changed. Here, when a change occurs in the stream rank, the smaller bit number is allocated equally to the CQIs of the superior stream and the inferior stream. Also, when no change occurs in the stream rank, the bit number is allocated such that the CQI bit number of the superior stream is decreased and the CQI bit number of the inferior stream is increased.

The CQI reproducing section 2910 reproduces the CQI indicating the received quality of each stream, by using the CQI information extracted by the CQI information extractor 607, the ranking information of respective streams extracted by the ranking information extractor 608, and the CQI bit allocation of respective streams decided by the CQI bit number allocation deciding section 2909. The adaptive controller 2911 controls the modulation system and the coding ratio of the transmission signal based on the reproduced CQI. Also, the adaptive controller 2911 applies the retransmission control at a time of retransmission when the transmitting apparatus receives the Nack signal from the receiving apparatus.

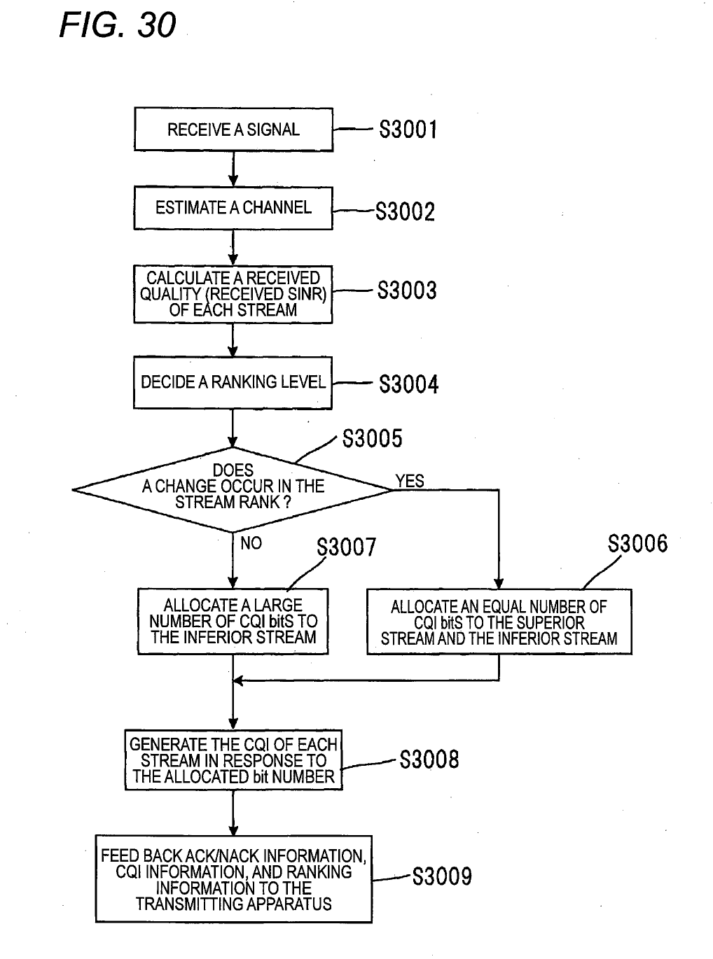

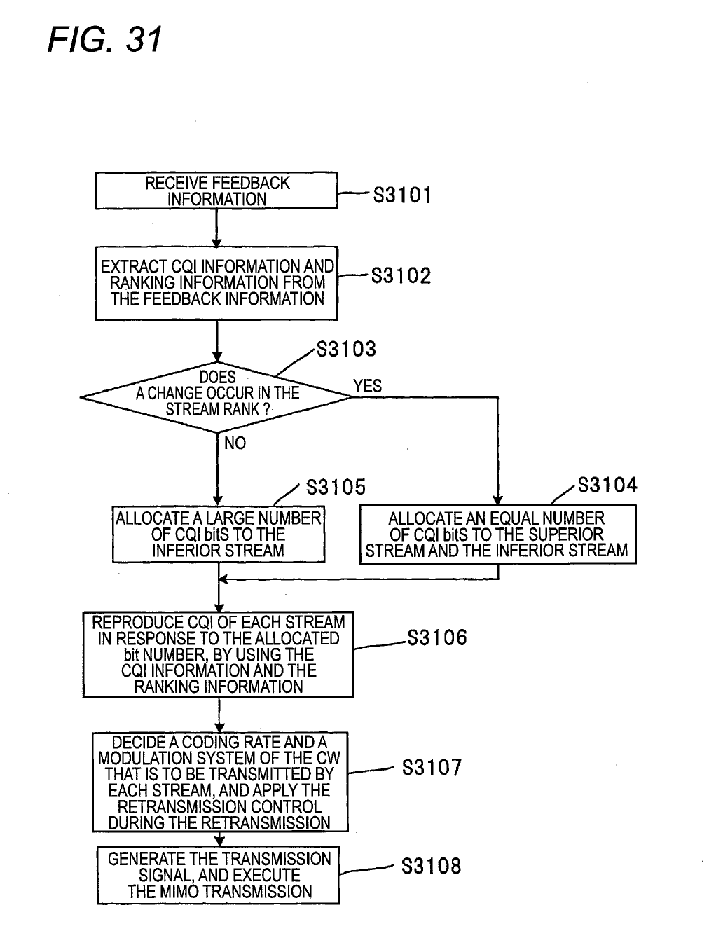

Next, a process flow in the radio communication apparatus of the fourth embodiment will be explained hereunder. FIG. 30 shows a process flow in the receiving apparatus of the fourth embodiment, and FIG. 31 shows a process flow in the transmitting apparatus of the fourth embodiment.

In the process flow of the receiving apparatus shown in FIG. 30, a different portion from the second embodiment resides in the processes in the stream rank change detector 2808 and the CQI bit number allocation deciding section 2809. In the receiving apparatus 2800, like the steps S1701 to S1704 in the second embodiment shown in FIG. 17, the MIMO receiver 503 receives the signal from the transmitting apparatus 2900 (S3001), the channel estimator 504 executes the channel estimation from the pilot signal (S3002), the received quality estimator 505 calculates and estimates the received quality of each stream by using the channel estimation value (S3003), and the stream ranking section 506 decides the ranking level by ranking respective streams by using the received quality of each stream (S3004).

Then, the stream rank change detector 2808 detects whether or not the ranking level of the stream is changed from the precedingly reported ranking level by using the ranking level of each stream in step S3004 (S3005).

Then, the CQI bit number allocation deciding section 2809 decides the allocation of the CQI bit number between the streams in response to whether or not a change in stream rank is caused. Here, when it is detected by the decision in S3005 that a change occurs in the stream rank, the CQI bit number allocation deciding section 2809 decides to allocate an equal number of CQI bits to the superior stream and the inferior stream (S3006). In contrast, when it is detected by the decision in S3005 that no change occurs in the stream rank, the CQI bit number allocation deciding section 2809 decides to allocate the bit number such that the CQI bit number of the superior stream is decreased and the CQI bit number of the inferior stream is increased (S3007).

Then, the feedback CQI information generator 2810 generates the CQI information of each stream, in response to the received quality of each stream estimated in step S3003, the ranking level of each stream decided in step S3004, and the CQI bit number of each stream decided in steps S3006, S3007 (S3008). Then, the feedback information transmitter 2811 feeds back the Ack/Nack information, the CQI information, and the ranking information to the transmitting apparatus 2900 (S3009).

Also, in the process flow in the receiving apparatus shown in FIG. 31, a different portion from the second embodiment resides in the processes in the the stream rank change detector 2906 and the CQI bit number allocation deciding section 2909. In the transmitting apparatus 2900, the feedback information receiver 605 receives the feedback information from the receiving apparatus 2800 (S3101). Then, the CQI information extractor 607 extracts the CQI information from the feedback information received in step S3101, and the ranking information extractor 608 extracts the ranking information from the feedback information (S3102).

Also, the stream rank change detector 2906 decides based on the ranking information extracted in S3102 whether or not a change in ranking level occurs in the stream rank from the precedingly reported stream rank (S3103), and detects whether or not a change occurs in the stream rank. Then, the CQI bit number allocation deciding section 2909 decides the allocation of the CQI bit number between the streams in response to whether or not a change in the stream rank is caused. Here, when a change occurs in the stream rank, the CQI bit number allocation deciding section 2909 decides to allocate an equal number of CQI bits to the superior stream and the inferior stream (S3104). In contrast, when no change occurs in the stream rank, the CQI bit number allocation deciding section 2909 decides to allocate the bit number such that the CQI bit number of the superior stream is decreased and the CQI bit number of the inferior stream is increased (S3105).

Then, the CQI reproducing section 2910 reproduces the CQI of each stream in response to the allocation of the CQI bit number decided in step S3104, step S3105, by using the CQI information and the ranking information extracted in step S3102 (S3106). Then, the adaptive controller 2911 decides the coding rate and the modulation system of the code word that is to be transmitted by each stream, based on CQI of each stream reproduced in step S3106. Also, the adaptive controller 2911 applies the retransmission control during the retransmission (S3107). Then, the transmission signal generator 601 and the MIMO transmitter 602 generate the transmission signal based on the coding rate and the modulation system of the code word decided in step S3107, and execute the MIMO transmission (S3108).

In this manner, according to the fourth embodiment, the allocation of the CQI bit number is changed when the ranking level of the streams is changed. Therefore, like the second embodiment, since a small number of CQI bits is allocated equally to the superior stream and the inferior stream, an amount of information required for the feedback can be reduced every code word even when the number of code words is increased.

Here, the present invention is not limited to the matters illustrated in the above embodiment. The present invention is susceptible to the variation and the application, which are made by those skilled in the are based on the description of the specification and the well-known technology and are contained in a scope within which a protection is sought.

The number of multiple streams and code words is illustrated as 2 or 4 by way of examples. But such number is not limited to these values, and any number can be applied.

In the above embodiments, explanation is made by taking as an example the case where the present invention is constructed by the hardware. But the present invention may be implemented by the software.

Also, typically respective function blocks used in the explanation of the above embodiments is implemented by LSI as the integrated circuit. These function blocks may be installed into one chip individually or one chip containing a part or all of these function blocks may be prepared. Here, LSI is mentioned, but IC, system LSI, super LSI, or ultra LSI may be referred to according to a difference in integration degree.

Also, the approach of setting up the integrated circuit is not limited to LSI, and the integrated circuit may be implemented by the dedicated circuit or the general-purpose processor. Also, FPGA (Field Programmable Gate Array) that is programmable after the LSI is manufactured, or reconfigurable processor in which the connection between circuit cells in the LSI and the settings are reconfigurable may be utilized.

Further, when the technology of setting up the integrated circuit is created with the progress of the semiconductor technology or by another derivative technology, respective function blocks may be of course integrated by using such technology. The application of biotechnology, and others may be considered as a possibility.

This application is based upon Japanese Patent Application (Patent Application No. 2007-211894) filed on Aug. 15, 2007; the contents of which are incorporated herein by reference.

### INDUSTRIAL APPLICABILITY

The present invention possesses such an advantage that errors in feedback information can be suppressed while reducing an amount of information required for the feedback every stream in the data transmission such as MCW, or the like using multiple streams, and is usable to the radio communication apparatus, the radio communication system, and the radio communication method, which are applicable to MIMO for performing communication by using multiple antennas, and the like.

1. A radio communication apparatus for performing data transmission by multiple code words in multiple streams and blanking transmission of retransmitting the code words to a communication partner station only in an superior stream, a received quality of which is excellent, out of the multiple streams in retransmitting the code words, the radio communication apparatus comprising:
a response signal generator which generates a response signal in response to a received result of the code words being transmitted from the communication partner station in the multiple streams;
a received quality information generator which generates received quality information indicating a received quality of each stream of the multiple streams;
a resource allocation controller which changes a resource allocation of the received quality information between the multiple streams based on whether or not a Nack signal of the response signal is present; and
a feedback information transmitter which transmits feedback information containing the response signal and the received quality information to the communication partner station.

2. The radio communication apparatus according to claim 1, wherein, when the Nack signal is not detected, the resource allocation controller controls the resource allocation such that a resource in the superior stream out of the multiple streams is decreased in the received quality information that is to be notified before transmission to which the blanking transmission is not applied.

3. The radio communication apparatus according to claim 1, wherein, when the Nack signal is detected, the resource allocation controller controls the resource allocation such that a resource in the superior stream out of the multiple streams is increased in the received quality information that is to be notified before transmission to which the blanking transmission is applied.

4. The radio communication apparatus according to claim 1, wherein, when the Nack signal is not detected, the resource allocation controller controls the resource allocation such that a resource in the inferior stream out of the multiple streams is increased larger than a resource in the superior stream in the received quality information that is notified before transmission to which the blanking transmission is not applied.

5. The radio communication apparatus according to claim 1, wherein, in such a situation that data transmission using four streams as the multiple streams is performed, when the Nack signal is detected, the resource allocation controller controls the resource allocation such that a resource in two superior streams out of four streams is increased in the received quality information that is to be notified before transmission to which the blanking transmission is applied.

6. The radio communication apparatus according to claim 3, wherein the resource allocation controller controls the resource allocation such that, when the Nack signal is caused from the code words being transmitted in the superior stream out of the multiple streams, a resource in the superior stream is increased, and also controls the resource allocation such that, when the Nack signal is caused from the code words being transmitted in the inferior stream out of the multiple streams, a resource in the superior stream is decreased.

7. The radio communication apparatus according to claim 6, wherein, when the Nack signal is caused from the code words being transmitted in the inferior stream, the feedback information transmitter add information indicating to what extent the code words being transmitted in the inferior stream is mistaken in the feedback information.

8. A radio communication apparatus for performing data transmission by multiple code words in multiple streams and blanking transmission for retransmitting the code words to a communication partner station only in an superior stream, a received quality of which is excellent, out of the multiple streams in retransmitting the code words, the radio communication apparatus comprising:
a feedback information receiver which receives feedback information from the communication partner station;
a response signal extractor which extracts a response signal that responds to a received result of the code words contained in the feedback information;
a resource allocation deciding section which decides a resource allocation of received quality information contained in the feedback information, in response to whether or not a Nack signal is caused as the response signal;
a received quality reproducing section which reproduces a received quality of each stream out of the multiple streams from the received quality information, based on the resource allocation; and
an adaptive controller which applies an adaptive control of the code words being transmitted in the multiple streams, based on the received quality.

9. The radio communication apparatus according to claim 8, wherein, when the Nack signal is not detected, the resource allocation deciding section decides the resource allocation such that a resource in the superior stream out of the multiple streams is decreased, and
the adaptive controller applies the adaptive control by using the received quality being reproduced based on the resource allocation, and performs normal transmission to which the blanking transmission is not applied.

10. The radio communication apparatus according to claim 8, wherein, when the Nack signal is detected, the resource allocation deciding section decides the resource allocation such that a resource in the superior stream out of the multiple streams is increased, and
the adaptive controller applies the adaptive control by using the received quality being reproduced based on the resource allocation, and performs the blanking transmission by using the superior stream.

11. The radio communication apparatus according to claim 8, wherein, when the Nack signal is not detected, the resource allocation deciding section decides the resource allocation such that a resource in the inferior stream out of the multiple streams is increased larger than a resource in the superior stream, and
the adaptive controller applies the adaptive control by using the received quality being reproduced based on the resource allocation, and performs normal transmission to which the blanking transmission is not applied.

12. The radio communication apparatus according to claim 8, wherein, in such a situation that data transmission using four streams as the multiple streams is performed, when the Nack signal is detected, the resource allocation deciding section decides the resource allocation such that a resource in two superior streams out of four streams is increased, and
the adaptive controller applies the adaptive control by using the received quality being reproduced based on the resource allocation, and performs the blanking transmission by using the two superior streams.

13. The radio communication apparatus according to claim 10, wherein the resource allocation deciding section decides the resource allocation such that, when the Nack signal is caused from the code words being transmitted in the superior stream out of the multiple streams, a resource in the superior stream is increased, and also decides the resource allocation such that, when the Nack signal is caused from the code words being transmitted in the inferior stream out of the multiple streams, a resource in the superior stream is decreased, and
the adaptive controller applies the adaptive control by using the received quality being reproduced based on the resource allocation, and performs the blanking transmission by using the superior stream.

14. A radio communication base station equipment equipped with the radio communication apparatus set forth in claim 1.

15. A radio communication mobile station equipment equipped with the radio communication apparatus set forth in claim 1.

16. (canceled)

17. A radio communication method applied in a radio communication apparatus for performing a data transmission held by multiple code words in multiple streams and blanking transmission for retransmitting the code words to a communication partner station only in an superior stream, a received quality of which is excellent, out of the multiple streams in retransmitting the code words, the radio communication method comprising:
generating a response signal in response to a received result of the code words being transmitted from the communication partner station in the multiple streams;
generating received quality information indicating a received quality of each stream of the multiple streams;
changing a resource allocation of the received quality information between the multiple streams based on whether or not a Nack signal of the response signal is present; and
transmitting feedback information containing the response signal and the received quality information to the communication partner station.

18. A radio communication method applied in a radio communication apparatus for performing data transmission by multiple code words in multiple streams and blanking transmission for retransmitting the code words to a communication partner station only in an superior stream, a received quality of which is excellent, out of the multiple streams in retransmitting the code words, the radio communication method comprising:
receiving feedback information from the communication partner station;
extracting a response signal that responds to a received result of the code words contained in the feedback information;
deciding a resource allocation of received quality information contained in the feedback information, in response to whether or not a Nack signal is caused as the response signal;
reproducing a received quality of each stream out of the multiple streams from the received quality information, based on the resource allocation; and
applying an adaptive control of the code words being transmitted in the multiple streams, based on the received quality.
